(19) United States
(12) Patent Application Publication
(10) Pub. No.: US 2024/0399746 A1
(43) Pub. Date: Dec. 5, 2024

(54) Ink Jet Recording Method And Ink Jet Recording Apparatus

(71) Applicant: SEIKO EPSON CORPORATION, Tokyo (JP)

(72) Inventor: Kosuke CHIDATE, Shiojiri (JP)

(21) Appl. No.: 18/680,184

(22) Filed: May 31, 2024

(30) Foreign Application Priority Data
Jun. 2, 2023 (JP) 2023-091543

(51) Int. Cl. B41J 2/15; B41J 2/21; B41J 3/407; C09D 11/322; C09D 11/38

(52) U.S. Cl. CPC B41J 2/15; B41J 2/2114; B41J 3/4078; C09D 11/322; C09D 11/38

(57) ABSTRACT

An ink jet recording method for performing recording by causing a carriage in which a first nozzle row, a second nozzle row, a third nozzle row, a fourth nozzle row, a fifth nozzle row, and a sixth nozzle row extending in a sub-scanning direction in which a recording medium is transported are arranged in this order in a main scanning direction intersecting the sub-scanning direction to perform reciprocating scanning in the main scanning direction, and discharging a first composition, a second composition, a third composition, a fourth composition, a fifth composition, and a sixth composition from the first nozzle row, the second nozzle row, the third nozzle row, the fourth nozzle row, the fifth nozzle row, and the sixth nozzle row, respectively, in both a forward pass and a return pass, the method including an ink attachment step of discharging an ink composition containing a pigment and resin particles and attaching the ink composition to the recording medium, and a reaction liquid attachment step of discharging a reaction liquid composition containing an aggregating agent that aggregates components of the ink composition and attaching the reaction liquid composition to the recording medium, in which a distance between the first nozzle row and the third nozzle row in the main scanning direction is equal to a distance between the fourth nozzle and the sixth nozzle in the main scanning direction, a distance between the second nozzle row and the third nozzle row in the main scanning direction is equal to a distance between the fourth nozzle and the fifth nozzle in the main scanning direction, the first composition and the sixth composition are the same composition, the second composition and the fifth composition are the same composition, the third composition and the fourth composition are the same composition, and nozzle rows that discharge a composition corresponding to the reaction liquid composition among the first composition, the second composition, and the third composition are provided in each or one independent ink jet head.

The present application is based on, and claims priority from JP Application Serial Number 2023-091543, filed Jun. 2, 2023, the disclosure of which is hereby incorporated by reference herein in its entirety.

### BACKGROUND

### 1. Technical Field

The present disclosure relates to an ink jet recording method and an ink jet recording apparatus.

### 2. Related Art

Attempts are made to apply an ink jet method to not only recording of images on paper and the like, but also textile printing on fabrics, and various ink jet textile printing methods are investigated. An ink jet ink for textile printing contains a coloring material in order to obtain an image having a desired color, and as the coloring material, dyes and pigments are used. In addition, in ink jet textile printing, many investigations are conducted on inks and recording methods.

Ink jet pigment textile printing has a simple process compared to analog textile printing and ink jet dye textile printing and is excellent in terms of low environmental load such as drainage. In the related art, a pretreatment (reaction liquid application) for pigment textile printing is often applied by an immersion method, but the immersion method generates a large amount of waste liquid. Therefore, in order to further reduce the environmental load in pigment textile printing, attempts are made to discharge the reaction liquid by ink jet.

For example, JP-A-2016-089288 discloses a configuration in which ink is attached without a drying step of a pre-reaction liquid composition in pigment textile printing.

However, in the technique described in JP-A-2016-089288, the timing for attachment of the pre-reaction liquid composition and the ink is not necessarily sufficiently considered. It is found that when an attempt is made to attach the reaction liquid composition and the ink composition by the ink jet method, it may be difficult to obtain a favorable image quality depending on the timing for attachment of the reaction liquid composition and the ink composition.

For example, in the ink jet method, it is found that in a case in which recording is performed by reciprocating in the main scanning direction using a serial type apparatus, when the timing for attachment of the reaction liquid composition and the ink composition is different on a forward pass and a return pass, deterioration in color developability or image quality (permeation unevenness, streaks) may occur. In addition, it is found that when the reaction liquid composition is applied to an ink jet method, there is a case where the reliability (clogging of nozzles derived from mist and reliability of waste liquid system) may decrease. Therefore, there is a demand for an ink jet recording method with favorable image quality, reliability, color developability, and productivity.

### SUMMARY

According to an aspect of the present disclosure, there is provided an ink jet recording method for performing recording by causing a carriage in which a first nozzle row, a second nozzle row, a third nozzle row, a fourth nozzle row, a fifth nozzle row, and a sixth nozzle row extending in a sub-scanning direction in which a recording medium is transported are arranged in this order in a main scanning direction intersecting the sub-scanning direction to perform reciprocating scanning in the main scanning direction, and discharging a first composition, a second composition, a third composition, a fourth composition, a fifth composition, and a sixth composition from the first nozzle row, the second nozzle row, the third nozzle row, the fourth nozzle row, the fifth nozzle row, and the sixth nozzle row, respectively, in both a forward pass and a return pass,
the method including
an ink attachment step of discharging an ink composition containing a pigment and resin particles and attaching the ink composition to the recording medium, and
a reaction liquid attachment step of discharging a reaction liquid composition containing an aggregating agent that aggregates components of the ink composition and attaching the reaction liquid composition to the recording medium, in which
a distance between the first nozzle row and the third nozzle row in the main scanning direction is equal to a distance between the fourth nozzle row and the sixth nozzle row in the main scanning direction,
a distance between the second nozzle row and the third nozzle row in the main scanning direction is equal to a distance between the fourth nozzle row and the fifth nozzle row in the main scanning direction,
the first composition and the sixth composition are the same composition,
the second composition and the fifth composition are the same composition, and
the third composition and the fourth composition are the same composition, and
nozzle rows that discharge a composition corresponding to the reaction liquid composition among the first composition, the second composition, and the third composition are provided in each or one independent ink jet head.

According to another aspect of the present disclosure, there is provided an ink jet recording apparatus including
a carriage in which a first nozzle row, a second nozzle row, a third nozzle row, a fourth nozzle row, a fifth nozzle row, and a sixth nozzle row extending in a sub-scanning direction in which a recording medium is transported are arranged in this order in a main scanning direction intersecting the sub-scanning direction, in which
recording is performed by performing reciprocating scanning in the main scanning direction, and discharging a first composition, a second composition, a third composition, a fourth composition, a fifth composition, and a sixth composition from the first nozzle row, the second nozzle row, the third nozzle row, the fourth nozzle row, the fifth nozzle row, and the sixth nozzle row, respectively, in both a forward pass and a return pass,
a distance between the first nozzle row and the third nozzle row in the main scanning direction is equal to a distance between the fourth nozzle row and the sixth nozzle row in the main scanning direction,
a distance between the second nozzle row and the third nozzle row in the main scanning direction is equal to a distance between the fourth nozzle row and the fifth nozzle row in the main scanning direction,
the first composition and the sixth composition are the same composition,
the second composition and the fifth composition are the same composition,
the third composition and the fourth composition are the same composition,
any one of the first composition, the second composition, and the third composition is a reaction liquid composition containing an aggregating agent, and
nozzle rows that discharge a composition corresponding to the reaction liquid composition among the first composition, the second composition, and the third composition are provided in each or one independent ink jet head.

### BRIEF DESCRIPTION OF THE DRAWINGS

FIG. 1 is a schematic view showing an example of a carriage included in a serial-type ink jet recording apparatus.

FIG. 2 is a schematic cross-sectional view of a printer which is an example of an ink jet recording apparatus that can carry out an ink jet recording method according to an embodiment.

FIG. 3 is a plan view schematically showing a positional relationship between a support base, an ink jet head, and a maintenance mechanism included in the printer in FIG. 2.

FIG. 4 is a plan view of the ink jet head shown in FIG. 2.

FIG. 5 is a perspective view of a maintenance unit in FIG. 3.

FIG. 6 is Table 1 showing compositions of reaction liquid compositions, ink compositions, and a clear ink composition used in Examples and Comparative Examples.

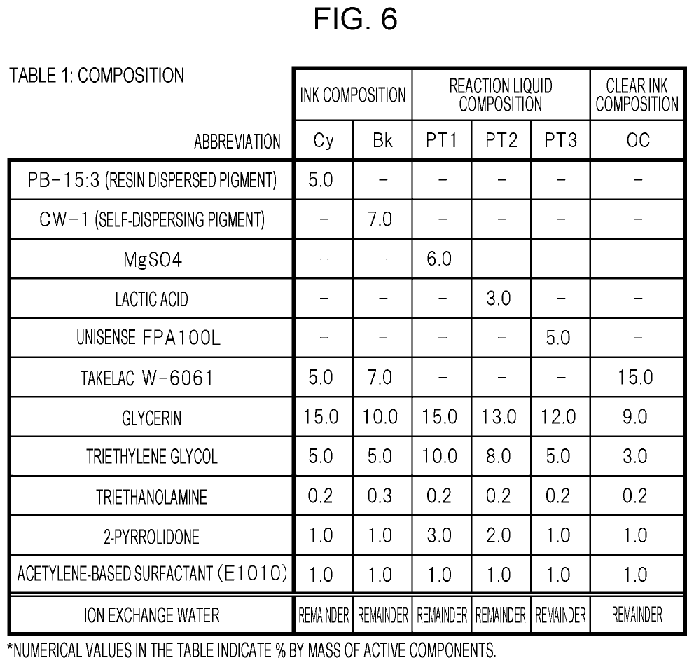

FIG. 7 is a diagram schematically showing ink jet heads, nozzle rows, and discharge compositions used in Examples and Comparative Examples.

FIG. 8 is a diagram schematically showing ink jet heads, nozzle rows, and discharge compositions used in Comparative Examples.

FIG. 9 is Table 2 showing conditions and evaluation results of Examples.

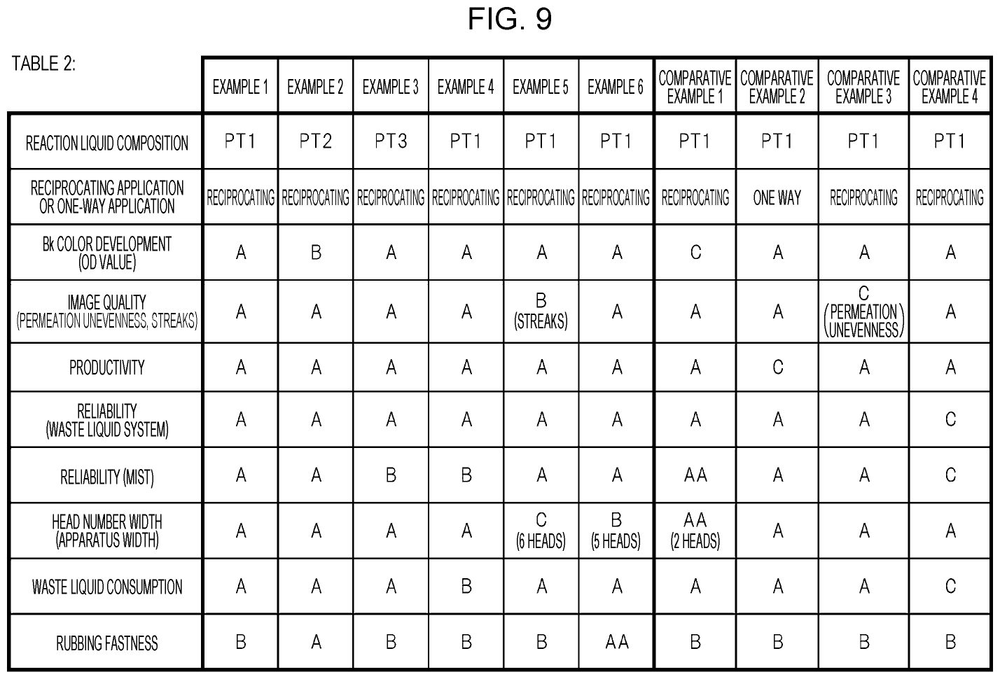

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

### 1. Ink Jet Recording Method

An ink jet recording method according to the present embodiment is an ink jet recording method for performing recording by causing a carriage in which a first nozzle row, a second nozzle row, a third nozzle row, a fourth nozzle row, a fifth nozzle row, and a sixth nozzle row extending in a sub-scanning direction in which a recording medium is transported are arranged in this order in a main scanning direction intersecting the sub-scanning direction to perform reciprocating scanning in the main scanning direction, and discharging a first composition, a second composition, a third composition, a fourth composition, a fifth composition, and a sixth composition from the first nozzle row, the second nozzle row, the third nozzle row, the fourth nozzle row, the fifth nozzle row, and the sixth nozzle row, respectively, in both a forward pass and a return pass.

In the ink jet recording method according to the present embodiment, a distance between the first nozzle row and the third nozzle row in the main scanning direction is equal to a distance between the fourth nozzle row and the sixth nozzle row in the main scanning direction, a distance between the second nozzle row and the third nozzle row in the main scanning direction is equal to a distance between the fourth nozzle row and the fifth nozzle row in the main scanning direction, the first composition and the sixth composition are the same composition, the second composition and the fifth composition are the same composition, the third composition and the fourth composition are the same composition.

Further, the ink jet recording method according to the present embodiment includes an ink attachment step of discharging an ink composition containing a pigment and resin particles and attaching the ink composition to the recording medium, and a reaction liquid attachment step of discharging a reaction liquid composition containing an aggregating agent that aggregates components of the ink composition and attaching the reaction liquid composition to the recording medium.

Further, in the ink jet recording method according to the present embodiment, nozzle rows that discharge a composition corresponding to the reaction liquid composition among the first composition, the second composition, and the third composition are provided in each or one independent ink jet head.

### 1.1. Nozzle Row and Carriage

In the ink jet recording method of the present embodiment, at least three types of compositions are respectively discharged from at least six nozzle rows mounted on a carriage, and the carriage performs reciprocating scanning in the main scanning direction and discharges the composition in both the forward pass and the return pass. Then, recording is performed so that the discharge order and the discharge timing of the compositions are the same in both the forward pass and the return pass.

In the present specification, a direction along a direction in which the recording medium is transported is defined as a Y direction, and is also referred to as a sub-scanning direction. Further, a direction in which the recording medium is transported is defined as a +Y direction, and is a direction toward the tip end of an arrow in the drawings. A direction intersecting the Y direction is defined as an X direction, and is referred to as a main scanning direction. The sub-scanning direction and the main scanning direction may not necessarily be orthogonal to each other, but in the description and drawings, a case in which the sub-scanning direction and the main scanning direction are orthogonal to each other will be illustrated.

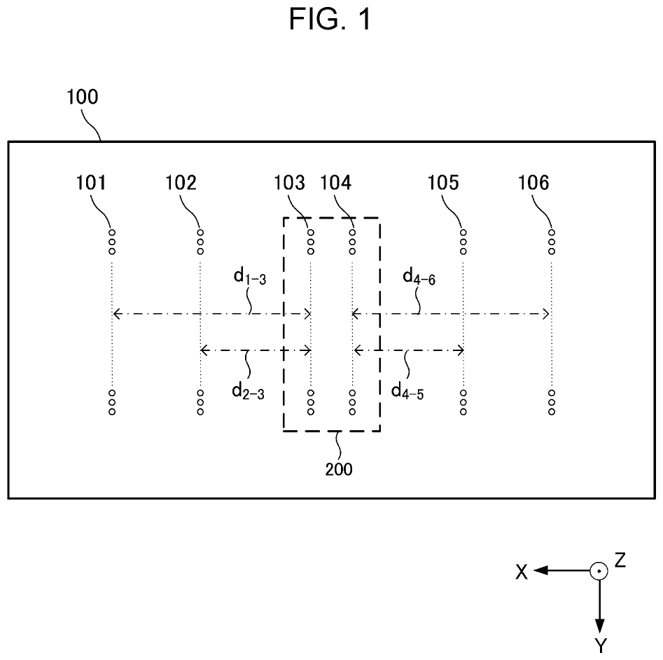

First, with reference to FIG. 1, an aspect of the nozzle row and the carriage that can carry out the ink jet recording method of the present embodiment will be described. FIG. 1 is a schematic view showing an example of a carriage and a nozzle row group arranged in the carriage provided in a serial-type ink jet recording apparatus.

In a carriage 100 shown in FIG. 1, a first nozzle row 101, a second nozzle row 102, a third nozzle row 103, a fourth nozzle row 104, a fifth nozzle row 105, and a sixth nozzle row 106 extending in the sub-scanning direction (Y direction) are arranged in this order in the main scanning direction (X direction) intersecting (orthogonal to) in the sub-scanning direction.

Further, the nozzle rows are arranged such that a distance d₁₋₃ between the first nozzle row 101 and the third nozzle row 103 in the main scanning direction is equal to a distance d₄₋₆ between the fourth nozzle row 104 and the sixth nozzle row 106 in the main scanning direction, and a distance d₂₋₃ between the second nozzle row 102 and the third nozzle row 103 in the main scanning direction is equal to a distance d₄₋₅ between the fourth nozzle row 104 and the fifth nozzle row 105 in the main scanning direction.

Further, a first composition, a second composition, a third composition, a fourth composition, a fifth composition, and a sixth composition are discharged from the first nozzle row 101, the second nozzle row 102, the third nozzle row 103, the fourth nozzle row 104, the fifth nozzle row 105, and the sixth nozzle row 106, respectively, the first composition and the sixth composition are the same composition, the second composition and the fifth composition are the same composition, and the third composition and the fourth composition are the same composition.

With such a configuration, when the carriage 100 discharges each composition from each nozzle row while reciprocating in the main scanning direction, the discharge order and the discharge timing of each composition are the same in the forward pass and the return pass. In other words, when each composition is attached to the recording medium from each nozzle row while the carriage 100 reciprocates at a constant speed in the main scanning direction, the landing order and the landing timing of each composition on the recording medium are the same in the forward pass and the return pass.

On the other hand, in the ink jet recording method of the present embodiment, a reaction liquid composition described later is attached to the recording medium. Such a reaction liquid composition is any one of the first composition, the second composition, and the third composition. For example, when the third composition is a reaction liquid composition, the reaction liquid composition is discharged from the third nozzle row 103 and the fourth nozzle row 104. In this case, each of the third nozzle row 103 and the fourth nozzle row 104 is formed in each or one independent ink jet head. In addition, for example, when the first composition is a reaction liquid composition, the reaction liquid composition is discharged from the first nozzle row 101 and the sixth nozzle row 106. In this case, the first nozzle row 101 and the sixth nozzle row 106 are formed in each independent ink jet heads. Similarly, when the second composition is a reaction liquid composition, the second nozzle row 102 and the fifth nozzle row 105 are formed in each independent ink jet head.

The example in FIG. 1 shows that the third nozzle row 103 and the fourth nozzle row 104 are formed in one independent ink jet head 200. Although the nozzle rows may belong to any ink jet head, the nozzle row that discharges the reaction liquid composition is configured to belong to an independent ink jet head.

As will be described later, the ink jet head may suction and discharge the discharged composition with a cap fitted for maintenance such as flushing. At this time, when the nozzle row that discharges the reaction liquid composition is formed in the same ink jet head as the nozzle row that discharges the composition including components aggregated by the reaction liquid composition, the aggregation of the components occurs in the waste liquid, and clogging easily occurs in a waste liquid pipe. However, with the above configuration, defects in the waste liquid can be reduced.

In addition, by configuring the nozzle row that discharges the reaction liquid composition to belong to an independent ink jet head, the mist generated when the reaction liquid composition is discharged or other compositions containing components aggregated by the reaction liquid composition are discharged is less likely to cause interference due to an increased distant distance between the nozzles, and defects such as nozzle clogging can be suppressed.

The configuration of the nozzle row and the ink jet head illustrated in FIG. 1 is an example, and in addition, for example, the number of nozzle rows, the number of ink jet heads, and the like can be appropriately changed. For example, in a case in which there are more nozzle rows, when the first to sixth nozzle rows that satisfy the above condition can be selected from these nozzle rows, the same effect can be obtained. In addition, with respect to the number of ink jet heads, when the nozzle rows that discharge the reaction liquid composition are configured to belong to the independent ink jet heads, the above-described effect can be obtained.

On the other hand, in FIG. 1, the first nozzle row 101 and the second nozzle row 102 may be formed in one ink jet head, the third nozzle row 103 and the fourth nozzle row 104 may be formed in one ink jet head, and the fifth nozzle row 105 and the sixth nozzle row 106 may be formed in one ink jet head. In this manner, since the arrangement of the ink jet heads in the carriage 100 can be shortened in the main scanning direction, the width of the carriage 100 can be reduced, and the apparatus can be further miniaturized.

In addition, in the example in FIG. 1, an example in which an even number of nozzle rows from the first nozzle row 101 to the sixth nozzle row 106 are provided is shown symmetrically, but it is understood that even when an odd number of nozzle rows are provided, the positions and the compositions to be discharged can be configured to be symmetrical about the nozzle row positioned at the center. Further, in the configuration including the symmetrical nozzle rows, one or more of the same configurations can be arranged side by side in the sub-scanning direction. In this case, the nozzle rows including the nozzle rows arranged in the sub-scanning direction may be arranged in one ink jet head. Even in such a case, the nozzle rows that discharge the reaction liquid composition are formed in each or one independent ink jet head.

Further, when six or more nozzle rows are arranged, a nozzle row that does not discharge the composition may be present. Even in such a case, the same effect can be obtained as long as the arrangements and the compositions to be discharged are symmetrical.

### 1.2. Ink Attachment Step

The ink jet recording method of the present embodiment includes an ink attachment step. The ink attachment step is a step of attaching an ink composition to a recording medium. Hereinafter, the ink composition will be described. The method of attachment to the recording medium will be described later.

### 1.2.1. Ink Composition

The ink composition contains at least a pigment and resin particles.

### 1.2.1. 1 Pigment

The ink composition is a so-called color ink which contains a pigment. Examples of the pigment contained in the ink composition include color pigments such as cyan, yellow, magenta, black, red, green, and orange pigments, and special color pigments such as a white pigment.

The pigment may be a mixture. The pigment is excellent in storage stability such as light resistance, weather resistance, and gas resistance, and is preferably an organic pigment from that viewpoint.

Specifically, as the pigment, azo pigments such as insoluble azo pigments, condensed azo pigments, azo lakes, and chelated azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, daylight fluorescent pigments, carbon black, and the like can be used. These pigments may be used alone or in combination of two or more thereof. Further, a white pigment, a photoluminescent pigment, or the like may be used as the pigment.

Specific examples of the pigments are not particularly limited, but examples thereof include the following.

Examples of black pigments include Bonjetblack CW-1 (manufactured by Orient Chemical Industries Co., Ltd.), No. 2300, No. 900, MCF 88, No. 33, No. 40, No. 45, No. 52, MA7, MA8, MA100, and No. 2200 B (all manufactured by Mitsubishi Chemical Corporation), Raven 5750, Raven 5250, Raven 5000, Raven 3500, Raven 1255, and Raven 700 (all manufactured by Columbia Carbon Inc.), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (manufactured by CABOT JAPAN K.K.), Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all manufactured by Degussa).

Examples of yellow pigments include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of magenta pigments include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, or C.I. Pigment Violet 19, 23, 32, 33, 36, 38, 43, and 50.

Examples of cyan pigments include C.I. Pigment Blue 1, 2, 3, 15, 15:1, 15:2, 15:3, 15:34, 15:4, 16, 18, 22, 25, 60, 65, and 66, and C.I. Bat blue 4 and 60.

In addition, pigments other than the magenta, cyan, and yellow pigments are not particularly limited and examples thereof include C.I. Pigment Green 7, 10, C.I. Pigment Brown 3, 5, 25, 26, and C.I. Pigment Orange 1, 2, 5, 7, 13, 14, 15, 16, 24, 34, 36, 38, 40, 43, and 63.

Examples of the white pigment include metal compounds such as metal oxide, barium sulfate, and calcium carbonate. Examples of the metal oxide include titanium dioxide, zinc oxide, silica, alumina, magnesium oxide, and the like. In addition, particles having a hollow structure may be used as the white pigment, and as the particles having a hollow structure, known particles can be used.

Suitably, the pigment can be stably dispersed in a dispersion medium, and for this purpose, a dispersant may be used to disperse the pigment. As the dispersant, there is provided a resin dispersant and the like, and the dispersant is selected from those that can improve dispersion stability of the pigment in the ink composition. In addition, the pigment may also be used as a self-dispersing pigment by modifying the surface of the pigment particles by oxidizing or sulfonating the pigment surface with, for example, ozone, hypochlorous acid, fuming sulfuric acid, or the like. The self-dispersing pigment is not a pigment dispersed by a dispersant or the like and is a self-dispersing type pigment that can be dispersed without using a dispersant or the like. The self-dispersing pigment contained in the ink composition may be, for example, a color pigment such as a black, cyan, yellow, magenta, red, green, or orange pigment, and a special color pigment such as a white pigment, which can be self-dispersible by an appropriate treatment.

Examples of the resin dispersant (dispersant resin) include (meth)acrylic resins such as poly(meth)acrylic acid, (meth)acrylic acid-acrylonitrile copolymers, (meth)acrylic acid-(meth)acrylic acid ester copolymers, vinyl acetate-(meth)acrylic acid ester copolymers, vinyl acetate-(meth)acrylic acid copolymers, and vinyl naphthalene-(meth)acrylic acid copolymers, and salts thereof; styrene-based resins such as styrene-(meth)acrylic acid copolymers, styrene-(meth)acrylic acid-(meth)acrylic acid ester copolymers, styrene-α-methylstyrene-(meth)acrylic acid copolymers, styrene-α-methylstyrene-(meth)acrylic acid-(meth)acrylic acid ester copolymers, styrene-maleic acid copolymers, and styrene-maleic acid anhydride copolymers, and salts thereof; urethane-based resins, which are polymer compounds (resins) having a urethane bond formed when an isocyanate group reacts with a hydroxyl group, and which may be linear and/or branched regardless of a crosslinked structure, and salts thereof; polyvinyl alcohols; vinyl naphthalene-maleic acid copolymers and salts thereof; vinyl acetate-maleic acid ester copolymers and salts thereof; and water-soluble resins such as vinyl acetate-crotonic acid copolymers and salts thereof. Among these, a copolymer of a monomer having a hydrophobic functional group and a monomer having a hydrophilic functional group, and a polymer formed of monomers having both a hydrophobic functional group and a hydrophilic functional group are preferable. As the form of the copolymer, any form of a random copolymer, a block copolymer, an alternating copolymer, and a graft copolymer can be used.

Examples of commercially available products of the styrene-based resin dispersant include X-200, X-1, X-205, X-220, and X-228 (manufactured by SEIKO PMC CORPORATION), NOPCOSPERSE (registered trademark) 6100 and 6110 (manufactured by SAN NOPCO LIMITED), Joncryl 67, 586, 611, 678, 680, 682, and 819 (manufactured by BASF SE), DISPER BYK-190 (manufactured by BYK Japan KK.), and N-EA137, N-EA157, N-EA167, N-EA177, N-EA197D, N-EA207D, and E-EN10 (manufactured by DKS Co., Ltd.).

In addition, examples of commercially available products of the acrylic resin dispersants include BYK-187, BYK-190, BYK-191, BYK-194N, and BYK-199 (manufactured by BYK Japan KK.), and Aron A-210, A6114, AS-1100, AS-1800, A-30SL, A-7250, and CL-2 (manufactured by TOAGOSEI CO., LTD.).

Further, examples of commercially available products of the urethane-based resin dispersant include BYK-182, BYK-183, BYK-184, and BYK-185 (manufactured by BYK Japan KK.), TEGO Dispers 710 (manufactured by Evonik Tego Chemi GmbH), and Borchi (registered trademark) Gen 1350 (manufactured by OMG Borchers GmbH).

These dispersants may be used alone or in combination of two or more thereof. The total content of the dispersant is preferably 0.1 parts by mass or more and 30 parts by mass or less, more preferably 0.5 parts by mass or more and 25 parts by mass or less, even more preferably 1 part by mass or more and 20 parts by mass or less, and still even more preferably 1.5 parts by mass or more and 15 parts by mass or less, with respect to 50 parts by mass of the pigment. When the content of the dispersant is 0.1 parts by mass or more with respect to 50 parts by mass of the pigment, the dispersion stability of the pigment can be further enhanced. In addition, when the content of the dispersant is 30 parts by mass or less with respect to 50 parts by mass of the pigment, the viscosity of the obtained dispersion can be suppressed to be small.

Among the dispersants exemplified above, it is more preferable that the dispersant is at least one selected from anionic dispersant resins. In addition, in this case, it is more preferable that a weight average molecular weight of the dispersant is 500 or more. Further, the weight average molecular weight is preferably 5,000 or more and 100,000 or less, and more preferably 10,000 or more and 50,000 or less.

By using such a resin dispersant as the dispersant, the dispersion and aggregation of the pigment are further improved, and an image having more favorable dispersion stability and more favorable image quality can be obtained.

The anionic dispersant resin is a resin in which the resin has an anionic functional group and exhibits anionic properties. Examples of the anionic functional group include a carboxyl group, a sulfo group, and a phosphoric acid group. Among these groups, a carboxyl group is more preferable.

The dispersant resin preferably has an acid value, and the acid value is preferably 5 mg KOH/g or more, more preferably 10 to 200 mg KOH/g, and even more preferably 15 to 150 mg KOH/g. Further, an acid value of 20 to 100 mg KOH/g is preferable, and an acid value of 25 to 70 mg KOH/g is more preferable.

The acid value can be measured by the neutralization titration method in accordance with JIS K 0070. As a titration device, for example, “AT610” manufactured by Kyoto Electronics Manufacturing Co., Ltd. can be used.

The content of the pigment is preferably 0.3% by mass or more and 20% by mass or less, and more preferably 0.5% by mass or more and 15% by mass or less with respect to the total mass of the ink composition. Further, the content is preferably 1% by mass or more and 10% by mass or less, and more preferably 2% by mass or more and 7% by mass or less.

In addition, the volume average particle diameter of the pigment particles is preferably 10 nm or more and 300 nm or less, more preferably 30 nm or more and 250 nm or less, even more preferably 50 nm or more and 250 nm or less, and particularly preferably 70 nm or more and 200 nm or less. Further, the volume average particle diameter is preferably 80 nm or more and 150 nm or less.

### 1.2.1. 2 Resin Particle

The ink composition contains resin particles. The resin particles can further improve the adhesion of an image due to the ink composition attached to the recording medium. As the resin particles, for example, there may be mentioned resin particles having anionic properties among resin particles formed of a urethane-based resin, an acrylic resin (including styrene-acrylic resin), a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, an ethylene vinyl acetate-based resin, and the like. Among these, a urethane-based resin, an acrylic resin, a polyolefin-based resin, and a polyester-based resin are preferable. These resin particles are often handled in the form of an emulsion, but may be in the form of powder. In addition, the resin particles can be used alone or in combination of two or more thereof.

Among these, the resin particle is more preferably a urethane resin. When urethane resin is selected, an image having more favorable rubbing fastness can be formed.

Urethane-based resin is a generic term for resins having a urethane bond. For the urethane-based resin, a polyether-type urethane resin including an ether bond in the main chain, a polyester-type urethane resin including an ester bond in the main chain, a polycarbonate-type urethane resin including a carbonate bond in the main chain, and the like, in addition to a urethane bond, may be used. In addition, as the urethane-based resin, commercially available products may be used, for example, the urethane-based resin selected from the commercially available products such as Superflex 460, 460s, 840, E-4000 (product name, manufactured by DKS Co., Ltd.), Resamine D-1060, D-2020, D-4080, D-4200, D-6300, D-6455 (product name, manufactured by Dainichiseika Color & Chemicals MFG Co., Ltd.), Takelac WS-6021, W-512-A-6 (product name, manufactured by Mitsui Chemicals Polyurethane Co., Ltd.), Sancure 2710 (product name, manufactured by LUBRIZOL), Permarin UA-150 (product name, manufactured by Sanyo Chemical Industries Ltd.), and the like may be used.

Acrylic resin is a generic term for polymers obtained by polymerizing at least acrylic monomers such as (meth)acrylic acid and (meth)acrylic acid ester as one component, and examples thereof include a resin obtained from an acrylic monomer and a copolymer of an acrylic monomer and other monomers. Examples thereof include an acrylic-vinyl-based resin which is a copolymer of an acrylic monomer and a vinyl-based monomer, and the like. In addition, examples of the vinyl-based monomer include styrene and the like.

As the acrylic monomer, acrylamide, acrylonitrile, and the like can also be used. For the resin emulsion using acrylic resin as a raw material, a commercially available product may be used, and for example, any resin emulsion may be selected and used from FK-854 (trade name, manufactured by CHIRIKA Co., Ltd.), Mowinyl 952B, 718A, and 6760 (trade names, manufactured by Japan Coating Resin Corporation), Nipol LX852 and LX874 (trade names, manufactured by Zeon Corporation), and the like.

Incidentally, in the present specification, the acrylic resin may be a styrene-acrylic resin described below. In addition, in the present specification, the notation of “(meth)acrylic” means at least one of acrylic and methacrylic.

The styrene-acrylic resin is a copolymer obtained from a styrene monomer and a (meth)acrylic monomer, and examples thereof include styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers. As the styrene-acrylic resin, a commercially available product may be used, and for example, Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, manufactured by BASF SE), Mowinyl 966A and 975N (trade names, manufactured by Japan Coating Resin Corporation), VINYBLAN 2586 (manufactured by Nissin Chemical Industry Co., Ltd.), and the like may be used.

The polyolefin-based resin has an olefin such as ethylene, propylene, or butylene in the structural skeleton, and known ones can be appropriately selected and used. As the olefin resin, a commercially available product can be used, for example, ARROWBASE CB-1200, CD-1200 (trade name, manufactured by Unitika Ltd.), and the like may be used.

In addition, the resin particles may be supplied in the form of an emulsion, and as examples of commercially available products of such a resin emulsion include Microgel E-1002 and E-5002 (trade names, manufactured by Nippon Paint Co. Ltd., styrene-acrylic resin emulsion), VONCOAT 4001 (trade name, manufactured by DIC Corporation, acrylic resin emulsion), VONCOAT 5454 (trade name, manufactured by DIC Corporation, styrene-acrylic resin emulsion), Polysol AM-710, AM-920, AM-2300, AP-4735, AT-860, and PSASE-4210E (acrylic resin emulsion), Polysol AP-7020 (styrene-acrylic resin emulsion), Polysol SH-502 (vinyl acetate resin emulsion), Polysol AD-13, AD-2, AD-10, AD-96, AD-17, and AD-70 (ethylene vinyl acetate resin emulsion), Polysol PSASE-6010 (ethylene vinyl acetate resin emulsion) (trade names, manufactured by Showa Denko KK), Polysol SAE1014 (trade name, styrene-acrylic resin emulsion, manufactured by Zeon Corporation), Saivinol SK-200 (trade name, acrylic resin emulsion, manufactured by Saiden Chemical Industry Co., Ltd.), AE-120A (trade name, manufactured by JSR Corporation, acrylic resin emulsion), AE373D (trade name, manufactured by Emulsion Technology Co., Ltd., carboxy-modified styrene-acrylic resin emulsion), Seikadyne 1900W (trade name, manufactured by Dainichiseika Color & Chemicals Mfg. Co., Ltd., ethylene vinyl acetate resin emulsion), VINYBLAN 2682 (acrylic resin emulsion), VINYBLAN 2886 (vinyl acetate acrylic resin emulsion), VINYBLAN 5202 (acetic acid acrylic resin emulsion) (trade names, manufactured by Nisshin Chemical Industry Co., Ltd.), Elitel KA-5071S, KT-8803, KT-9204, KT-8701, KT-8904, and KT-0507 (trade names, manufactured by Unitika Ltd., polyester resin emulsion), Hi-Tech SN-2002 (trade name, manufactured by TOHO CHEMICAL INDUSTRY Co., Ltd., polyester resin emulsion), TAKELAK W-6020, W-635, W-6061, W-605, W-635, and W-6021 (trade names, manufactured by Mitsui Chemicals & SKC Polyurethanes Inc., urethane-based resin emulsion), SUPERFLEX 870, 800, 150, 420, 460, 470, 610, and 700 (trade names, manufactured by DKS Co., Ltd., urethane-based resin emulsion), PERMARIN UA-150 (manufactured by Sanyo Chemical Industries, Ltd., urethane-based resin emulsion), Sancure 2710 (manufactured by Japanese Lubrizol Corporation, urethane-based resin emulsion), NeoRez R-9660, R-9637, and R-940 (manufactured by Kusumoto Chemicals, Ltd., urethane-based resin emulsion), ADEKA BONTIGHTER HUX-380 and 290K (manufactured by ADEKA Corporation, urethane-based resin emulsion), Mowinyl 966A and Mowinyl 7320 (manufactured by Japan Coating Resin Corporation), Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (manufactured by BASF SE), NK binder R-5HN (manufactured by Shin-Nakamura Chemical Co., Ltd.), HYDRAN WLS-210 (non-crosslinkable polyurethane: manufactured by DIC Corporation), and Joncryl 7610 (manufactured by BASF SE). Any of these may be selected and used.

The content of the resin particles in the ink composition is 0.1% by mass or more and 20% by mass or less, preferably 1% by mass or more and 15% by mass or less, more preferably 3% by mass or more and 7% by mass or less, and particularly preferably 3% by mass or more and 5% by mass or less, as a solid content with respect to the total mass of the ink composition.

### 1.2.1. 3 Other Components

The ink composition may contain the following components.

### Water

The ink composition may include water. Examples of water include pure water such as ion exchange water, ultrafiltered water, reverse osmosis water, and distilled water, and water such as ultrapure water, from which ionic impurities are removed as much as possible. In addition, when water sterilized by irradiation with ultraviolet rays, addition of hydrogen peroxide, or the like is used, the generation of bacteria or fungi when the composition is stored for a long period of time can be reduced.

The content of water is 30% by mass or more, preferably 40% by mass or more, more preferably 45% by mass or more, and even more preferably 50% by mass or more with respect to the total amount of the ink composition. The term water in the ink composition includes, for example, crystal water included in the raw material or water to be added. When the water content is set to 30% by mass or more, the ink composition can have a relatively low viscosity. Further, the upper limit of the content of the water is preferably 90% by mass or less, more preferably 85% by mass or less, and even more preferably 80% by mass or less, with respect to the total amount of the ink composition. In the present specification, the term “aqueous composition” refers to a composition containing 30% by mass or more of water with respect to the total mass (100% by mass) of the composition.

### Organic Solvent

The ink composition used in the recording method according to the present embodiment may contain an organic solvent. The organic solvent is preferably water-soluble. One of the functions of the organic solvent is to improve the wettability of the ink composition with respect to a fabric or to enhance the moisture retention properties of the ink composition. In addition, the organic solvent can also function as a penetrant.

Examples of the organic solvent include esters, alkylene glycol ethers, cyclic esters, nitrogen-containing solvents, and polyhydric alcohols. Examples of the nitrogen-containing solvents include cyclic amides and acyclic amides. Examples of the acyclic amides include alkoxyalkylamides.

Examples of the esters include glycol monoacetates such as ethylene glycol monomethyl ether acetate, ethylene glycol monoethyl ether acetate, and ethylene glycol monobutyl ether acetate, and glycol diesters such as ethylene glycol diacetate, diethylene glycol diacetate, and propylene glycol diacetate.

The alkylene glycol ethers may be alkylene glycol monoethers or diethers, and alkyl ethers are preferable. Specific examples thereof include alkylene glycol monoalkyl ethers such as ethylene glycol monomethyl ether, ethylene glycol monoethyl ether, ethylene glycol monoisopropyl ether, ethylene glycol monobutyl ether, and diethylene glycol monomethyl ether, and alkylene glycol dialkyl ethers such as ethylene glycol dimethyl ether, ethylene glycol diethyl ether, ethylene glycol dibutyl ether, diethylene glycol dimethyl ether, and diethylene glycol diethyl ether.

Examples of the cyclic esters include cyclic esters (lactones) such as β-propiolactone, γ-butyrolactone, δ-valerolactone, ε-caprolactone, and β-butyrolactone, and compounds in which a hydrogen of a methylene group adjacent to a carbonyl group thereof is substituted with an alkyl group having 1 to 4 carbon atoms.

Examples of the alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, and 3-n-butoxy-N,N-methylethylpropionamide.

Examples of the cyclic amides include lactams, and examples thereof include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone.

In addition, it is also preferable to use compounds represented by Formula (1) as the alkoxyalkylamides.

R¹—O—CH₂CH₂—(C═O)—NR²R³ (1)

In Formula (1), R¹ represents an alkyl group having 1 or more and 4 or less carbon atoms, and R² and R³ each independently represent a methyl group or an ethyl group. The “alkyl group having 1 or more and 4 or less carbon atoms” may be a linear or branched alkyl group, and examples thereof include a methyl group, an ethyl group, an n-propyl group, an iso-propyl group, an n-butyl group, a sec-butyl group, an iso-butyl group, and a tert-butyl group. The compounds represented by Formula (1) may be used alone or as a mixture of two or more thereof.

Examples of the function of the nitrogen-containing solvent include enhancing the surface dryness and fixability of the ink composition attached to the fabric.

The content of the nitrogen-containing solvent is not particularly limited, and is about 5% by mass or more and 50% by mass or less, and preferably 10% by mass or more and 30% by mass or less with respect to the total mass of the ink composition. When the content of the nitrogen-containing solvent is within the above range, the fixability and surface dryness of the image (particularly, the surface dryness when an image is recorded under an environment of high temperature and high humidity) can be further improved in some cases.

Examples of the polyhydric alcohols include 1,2-alkanediol (for example, alkanediols such as ethylene glycol, propylene glycol (alias: propane-1,2-diol), 1,2-butanediol, 1,2-pentanediol, 1,2-hexanediol, 1,2-heptanediol, and 1,2-octanediol), and polyhydric alcohols (polyols) excluding the 1,2-alkanediol (for example, diethylene glycol, dipropylene glycol, 1,3-propanediol, 1,3-butanediol (alias: 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylol propane, and glycerin).

The polyhydric alcohols can be divided into alkanediols and polyols. The alkanediols are diols of an alkane having 5 or more carbon atoms. The number of carbon atoms of the alkane is preferably 5 to 15, more preferably 6 to 10, and even more preferably 6 to 8. 1,2-alkanediol is preferable.

The polyols are polyols of alkane having 4 or less carbon atoms or intermolecular condensates of hydroxyl groups of polyols of alkane having 4 or less carbon atoms. The number of carbon atoms of the alkane is preferably 2 to 3. The number of the hydroxyl groups in the molecule of the polyols is 2 or more, preferably 5 or less, and more preferably 3 or less. When the polyols are the intermolecular condensates described above, the number of intermolecular condensates is 2 or more, preferably 4 or less, and more preferably 3 or less. The polyhydric alcohols may be used alone or as a mixture of two or more types thereof.

The alkanediols and polyols can mainly function as a penetrating solvent and/or a moisturizing solvent. However, the alkanediols tend to have strong properties as the penetrating solvent, and polyols tend to have strong properties as the moisturizing solvent.

When the ink composition contains an organic solvent, the organic solvent may be used alone, or may be used in combination of two or more thereof. In addition, the total content of the organic solvent is, for example, 5% by mass or more and 50% by mass or less, preferably 10% by mass or more and 45% by mass or less, more preferably 15% by mass or more and 40% by mass or less, and even more preferably 20% by mass or more and 40% by mass or less, with respect to the total mass of the ink composition. When the content of the organic solvent is within the above range, the balance between wet spreadability and dryness is further improved, and an image with a high image quality is easily formed

The colored ink composition preferably contains a polyhydric alcohol, and more preferably contains a polyhydric alcohol having a normal boiling point of 250° C. or higher as the organic solvent. In addition, the content of the polyhydric alcohol having a normal boiling point of 250° C. or higher is preferably 1% by mass or more, more preferably 5% by mass or more, even more preferably 10% by mass or more, still even more preferably 13% by mass or more, and particularly preferably 15% by mass or more, with respect to the total amount of the ink composition. Although the upper limit is not particularly limited, the upper limit is preferably 40% by mass or less, more preferably 35% by mass or less, even more preferably 30% by mass or less, still even more preferably 25% by mass or less, and particularly preferably 20% by mass or less. When the content of the polyhydric alcohol having a normal boiling point of 250° C. or higher is within the above range, there is a tendency that the balance between moisture retention properties and dryness is excellent, and both intermittent printing stability and rubbing fastness can be improved.

### Surfactant

The ink composition may contain a surfactant. The surfactant has a function of adjusting the surface tension of the ink composition and adjusting, for example, the wettability with the fabric. Among the surfactants, for example, an acetylene glycol-based surfactant, a silicone-based surfactant, and a fluorine-based surfactant can be preferably used.

The acetylene glycol-based surfactant is not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all trade names, manufactured by Air Products & Chemicals. Inc.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all trade names, manufactured by Nissin Chemical Industry Co., Ltd.), and ACETYLENOL E00, E00P, E40, and E100 (all trade names, manufactured by Kawaken Fine Chemicals Co., Ltd.).

The silicone-based surfactant is not particularly limited, and examples thereof preferably include a polysiloxane-based compound. The polysiloxane-based compound is not particularly limited, and examples thereof include a polyether-modified organosiloxane. Examples of commercially available products of the polyether-modified organosiloxane include BYK-306, BYK-307, BYK-333, BYK-341, BYK-345, BYK-346, and BYK-348 (all trade names, manufactured by BYK Japan KK.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all trade names, manufactured by Shin-Etsu Chemical Co., Ltd.), and SILFACE SAG002, 005, 503A, 008 (all trade names, manufactured by Nissin Chemical Industry Co., Ltd.).

As the fluorine-based surfactant, a fluorine-modified polymer is preferably used, and specific examples thereof include BYK-3440 (manufactured by BYK Japan KK.), SURFLON S-241, S-242, and S-243 (all trade names, manufactured by AGC SEIMI CHEMICAL CO., LTD.), and FTERGENT 215M (manufactured by NEOS COMPANY LIMITED).

When the ink composition contains a surfactant, a plurality of types of surfactants may be contained. When the ink composition contains a surfactant, the content thereof can be set to 0.1% by mass or more and 2% by mass or less, preferably 0.4% by mass or more and 1.5% by mass or less, and more preferably 0.5% by mass or more and 1.0% by mass or less with respect to the total mass of the ink composition.

### Wax

The ink composition may contain a wax. Since the wax has a function of imparting smoothness to an image due to the ink composition, peeling of the image due to the ink composition can be reduced.

Examples of the components constituting the wax include plant or animal waxes such as carnauba wax, candelilla wax, beeswax, rice wax, and lanolin; petrolatum waxes, such as paraffin wax, microcrystalline wax, polyethylene wax, oxidized polyethylene wax, and petrolatum; mineral waxes, such as montan wax and ozokerite; synthetic waxes such as carbon wax, Hoechst wax, polyolefin wax, and stearic acid amide; and emulsions of natural synthetic waxes or compounded waxes such as an α-olefin maleic anhydride copolymer. These waxes can be used alone or a mixture of a plurality of types thereof may be used. Among these, from a viewpoint of obtaining more excellent in the effect of enhancing the fixability to a soft packaging film to be described later, it is preferable to use the polyolefin wax (in particular, polyethylene wax and polypropylene wax) and the paraffin wax.

As the wax, a commercially available product can be used as it is, and examples thereof include NOPCOTE PEM-17 (trade name, manufactured by SAN NOPCO LIMITED), CHEMIPEARL W4005 (trade name, manufactured by Mitsui Chemicals, Inc.), and AQUACER 515, 539, and 593 (all trade names, manufactured by BYK Japan KK.).

The wax may be supplied in the form of an emulsion or suspension. When the wax is used, the content thereof is preferably 0.1% by mass or more and 10% by mass or less, more preferably 0.5% by mass or more and 5% by mass or less, and even more preferably 0.5% by mass or more and 2% by mass or less, with respect to the total mass of the ink composition, in terms of solid content. When the content of the wax is within the above range, the function of the wax can be satisfactorily exhibited.

### Additive

The ink composition may contain ureas, amines, saccharides and the like as additives. Examples of ureas include urea, ethyleneurea, tetramethylurea, thiourea, and 1,3-dimethyl-2-imidazolidinone, and betaines (such as trimethylglycine, triethylglycine, tripropylglycine, triisopropylglycine, N,N,N-trimethylalanine, N,N,N-triethylalanine, N,N,N-triisopropylalanine, N,N,N-trimethyl methyl alanine, carnitine, and acetyl carnitine).

Examples of the amines include diethanolamine, triethanolamine, and triisopropanolamine. The ureas or the amines may function as a pH adjuster.

Examples of the saccharides include glucose, mannose, fructose, ribose, xylose, arabinose, galactose, aldonic acid, glucitol (sorbitol), maltose, cellobiose, lactose, sucrose, trehalose, and maltotriose.

### pH Adjuster

A pH adjuster can be added to the ink composition of the present embodiment in order to adjust the pH. The pH adjuster is not particularly limited, and examples thereof include an appropriate combination of acids, bases, weak acids, and weak bases. Examples of acids and bases used in such a combination include inorganic acids such as sulfuric acid, hydrochloric acid, and nitric acid, inorganic bases such as lithium hydroxide, sodium hydroxide, potassium hydroxide, dihydrogen potassium phosphate, hydrogen disodium phosphate, potassium carbonate, sodium carbonate, hydrogen sodium carbonate, and ammonia, organic bases such as triethanol amine, diethanol amine, monoethanol amine, tripropanol amine, triisopropanol amine, diisopropanol amine, and tris(hydroxymethyl)aminomethane (THAM), and organic acids such as adipic acid, citric acid, succinic acid, lactic acid, Good's buffers such as N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyl iminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycine amide, and bicine, a phosphate buffer solution, a citrate buffer solution, and a tris buffer solution. Further, among these, a tertiary amine such as triethanolamine or triisopropanolamine and a carboxy group-containing organic acid such as adipic acid, citric acid, succinic acid, or lactic acid are preferably contained as a part or the whole of the pH adjuster since the pH buffering effect can be more stably obtained.

### Ureas

Ureas may be used as a moisturizer of the ink composition. Specific examples of the ureas include urea, ethylene urea, tetramethylurea, thiourea, and 1,3-dimethyl-2-imidazolidinone. When the ureas are contained, the content thereof may be 1% by mass or more and 10% by mass or less with respect to the total mass of the ink composition.

### Saccharides

Saccharides may be used for the purpose of suppressing solidification and drying of the ink composition. Specific examples of saccharides include glucose, mannose, fructose, ribose, xylose, arabinose, galactose, aldonic acid, glucitol (sorbitol), maltose, cellobiose, lactose, sucrose, trehalose, and maltotriose.

### Chelating Agent

A chelating agent may be used for the purpose of removing unnecessary ions in the ink composition. Examples of the chelating agent include ethylenediaminetetraacetic acid and salts thereof (such as ethylenediaminetetraacetic acid dihydrogen disodium salt, ethylene diamine nitrilotriacetate, hexametaphosphate, pyrophosphate, and metaphosphate).

### Preservative and Fungicide

A preservative and a fungicide may be used in the ink composition. Examples of the preservative and the fungicide include sodium benzoate, sodium pentachlorophenolate, sodium 2-pyridinethiol-1-oxide, sodium sorbate, sodium dehydroacetate, PROXEL CRL, PROXEL BDN, PROXEL GXL, PROXEL XL-2, PROXEL IB, and PROXEL TN (trade names, all manufactured by LONZA KK.), and 4-chloro-3-methylphenol (such as PREVENTOL CMK manufactured by Bayer AG).

### Rust Inhibitor

A rust inhibitor may be used in the ink composition. Preferable examples of the rust inhibitor include benzotriazole, acidic sulfite, sodium thiosulfate, ammonium thioglycolic acid, diisopropylammonium nitrite, pentaerythritol tetranitrate, and dicyclohexylammonium nitrite. Among these, benzotriazole is particularly suitable.

### Others

The ink composition used in the recording method according to the present embodiment may further contain components such a viscosity adjusting agent, an antioxidant, an antifungal agent, an oxygen absorber, and a dissolution aid, as necessary.

### 1.2.1. 4 Physical Properties and Production of Ink Composition

When the ink composition is attached to the recording medium by an ink jet method, the viscosity of the ink composition at 20° C. is preferably 1.5 mPa·s or more and 15 mPa·s or less, more preferably 1.5 mPa·s or more and 7 mPa·s or less, and even more preferably 1.5 mPa·s or more and 5.5 mPa·s or less. When the ink composition is attached to the recording medium by the ink jet method, it is easy to efficiently form a predetermined image on the recording medium.

The surface tension of the ink composition at 25° C. is 40 mN/m or less, preferably 38 mN/m or less, and more preferably 35 mN/m or less from a viewpoint of obtaining appropriate wet spreadability on the recording medium. In addition, the surface tension is preferably 20 mN/m or more, and more preferably 25 mN/m or more.

The surface tension can be measured by confirming the surface tension when a platinum plate is wetted with the composition in an environment of 25° C. using an automatic surface tensiometer CBVP—Z (manufactured by Kyowa Interface Science, Co., Ltd.).

The ink composition is obtained by mixing the components described above in an arbitrary order and, as necessary, carrying out filtration or the like to remove impurities. As a method of mixing each component, a method of sequentially adding materials to a container equipped with a stirring device such as a mechanical stirrer and a magnetic stirrer, and performing stirring and mixing is suitably used. As a filtration method, centrifugal filtration, filter filtration, and the like can be performed as necessary.

### 1.2.2. Method of Attaching Ink Composition to Recording Medium

The ink attachment step may be performed by any method provided that an ink jet method having a form in which the ink composition is attached to a recording medium while an ink jet head scans the recording medium is used. In the ink jet method, main scanning is performed a plurality of times for recording by moving the ink jet head in a direction perpendicular to a transport direction of the recording medium. Although the details will be described later, the ink composition and the reaction liquid composition are attached to the same scanning region of the recording medium by the same main scanning.

The attachment amount of the ink composition in the ink attachment step is preferably 5.0 (mg/inch²) or more. Further, the attachment amount of the ink composition is preferably 7.0 (mg/inch²) or more, more preferably 9.0 (mg/inch²) or more, even more preferably 10.0 (mg/inch²) or more, yet even more preferably 13.0 (mg/inch²) or more, and still even more preferably 15.0 (mg/inch²) or more. In this manner, a colored image having more favorable color developability can be obtained.

Further, the upper limit is preferably 50.0 (mg/inch²) or less, more preferably 40.0 (mg/inch²) or less, and even more preferably 25.0 (mg/inch²) or less.

The attachment amount of the ink composition described above is applied in the recording region where the reaction liquid composition and ink composition are overlapped and attached in the recording method of the present embodiment. In addition, the maximum attachment amount of the ink composition in the region may be within the above range, which is preferable.

### 1.3. Reaction Liquid Attachment Step

The reaction liquid attachment step is a step of attaching the reaction liquid composition to the recording medium. Hereinafter, the reaction liquid composition will be described. The method of attachment to the recording medium will be described later.

### 1.3.1. Reaction Liquid Composition

The reaction liquid composition contains at least an aggregating agent that aggregates components of the ink composition. The aggregating agent has an effect of aggregating the pigment and the resin particles by reacting with the components such as the pigment included in the ink composition and the resin particles included in the ink composition and the clear ink composition. For example, due to such aggregation, the color development of the pigment can be enhanced, the fixability of the resin particles can be enhanced, and/or the viscosity of the ink can be increased.

### 1.3.1. 1 Aggregating Agent

Although the aggregating agent is not particularly limited, examples thereof include a metal salt, an inorganic acid, an organic acid, and a cationic compound, and as the cationic compound, a cationic resin (cationic polymer), a cationic surfactant, and the like can be used. Among these, a polyvalent metal salt is preferable as the metal salt, and a cationic resin is preferable as the cationic compound. Therefore, the aggregating agent is more preferably selected from a polyvalent metal salt, an organic acid, and a cationic polymer from the viewpoint of obtaining particularly excellent color developability, image quality, abrasion resistance, gloss, and the like.

The metal salt is preferably a polyvalent metal salt, but metal salts other than polyvalent metal salts can be used. Among these aggregating agents, it is preferable to use at least one selected from a metal salt and an organic acid from the viewpoint of excellent reactivity with components included in the ink. In addition, among the cationic compounds, cationic resins are preferably used from the viewpoint of easy dissolution in the treatment liquid. In addition, a plurality of types of aggregating agents can be used in combination.

The polyvalent metal salt is a compound formed of a divalent or higher metal ion and an anion. Examples of the divalent or higher metal ion include ions such as calcium, magnesium, copper, nickel, zinc, barium, aluminum, titanium, strontium, chromium, cobalt, iron, and the like. Among the metal ions constituting these polyvalent metal salts, the metal ion is preferably at least one of calcium ion and magnesium ion from the viewpoint of an excellent aggregating property of the components of the ink.

The anion constituting the polyvalent metal salt is an inorganic ion or an organic ion. That is, the polyvalent metal salt in the present disclosure is formed of an inorganic ion or an organic ion and a polyvalent metal. Examples of the inorganic ion include a chloride ion, a bromine ion, an iodine ion, a nitrate ion, a sulfate ion, and a hydroxide ion. Examples of the organic ion include an organic acid ion, and examples thereof include a carboxylic acid ion.

The polyvalent metal compound is preferably an ionic polyvalent metal salt, and in particular, when the polyvalent metal salt is a magnesium salt or a calcium salt, the stability of the treatment liquid is further improved. In addition, as the counter ion of the polyvalent metal, any of an inorganic acid ion and an organic acid ion may be used.

Specific examples of the polyvalent metal salt include a calcium carbonate such as a heavy calcium carbonate and a light calcium carbonate, calcium nitrate, calcium chloride, calcium sulfate, magnesium sulfate, calcium hydroxide, magnesium chloride, magnesium carbonate, barium sulfate, chloride barium, zinc carbonate, zinc sulfide, aluminum silicate, calcium silicate, magnesium silicate, copper nitrate, calcium formate, calcium acetate, magnesium acetate, and aluminum acetate. These polyvalent metal salts may be used alone, or may be used in combination of two or more thereof. Among these, since sufficient solubility in water can be secured and the use thereof reduces traces of the treatment liquid (makes traces less visible), at least any one of calcium formate, magnesium sulfate, calcium nitrate, and calcium chloride is preferable, and calcium formate or calcium nitrate is more preferable. In addition, these metal salts may have hydration water in the form of a raw material.

Examples of the metal salt other than the polyvalent metal salt include monovalent metal salts such as sodium salt and potassium salt, and for example, there are mentioned sodium sulfate, potassium sulfate, and the like.

Preferable examples of the organic acid include poly(meth)acrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyrone carboxylic acid, pyrrole carboxylic acid, furancarboxylic acid, pyridine carboxylic acid, coumaric acid, thiophene carboxylic acid, nicotinic acid, derivatives of these compounds, and salts thereof. The organic acid may be used alone or in combination of two or more thereof. Metal salts which are salts of organic acids are included in the metal salts described above.

Examples of the inorganic acid include sulfuric acid, hydrochloric acid, nitric acid, phosphoric acid, and the like. The inorganic acid may be used alone or in combination of two or more thereof.

Examples of the cationic resin (cationic polymer) include a cationic acrylic resin, a cationic urethane-based resin, a cationic olefin-based resin, a cationic amine-based resin, and a cationic surfactant. The cationic polymer is preferably water-soluble.

As the cationic acrylic resin, commercially available products can be used, and examples thereof include SUPERFLEX (registered trademark) 620 and 650, manufactured by DKS Co., Ltd., PARASURF UP-22 manufactured by Ohara Paragium Chemical Co., Ltd., PERMARIN (registered trademark) UC-20 manufactured by Sanyo Chemical Industries, Ltd., ARROWBASE (registered trademark) CB-1200 and CD-1200 manufactured by Unitika, VINYBLAN (registered trademark) 2687 manufactured by Nissin Chemical Industry Co., Ltd., and Mowinyl 7820 manufactured by Japan Coating Resin Corporation.

Commercially available products can be used as the cationic urethane-based resin, and for example, HYDRAN CP-7010, CP-7020, CP-7030, CP-7040, CP-7050, CP-7060, and CP-7610 (trade names, manufactured by DIC Corporation), SUPERFLEX 600, 610, 620, 630, 640, and 650 (trade name, manufactured by DKS Co., Ltd.), urethane emulsion WBR-2120C and WBR-2122C (trade names, manufactured by Taisei Fine Chemical Co., Ltd.), and the like can be used.

The cationic olefin resin is a resin having an olefin such as ethylene and propylene in the structural skeleton, and known ones can be appropriately selected and used. In addition, the cationic olefin resin may be in an emulsion state of being dispersed in a solvent containing water, an organic solvent, or the like. As the cationic olefin resin, a commercially available product can be used, and examples thereof include arrow base CB-1200 and CD-1200 (trade name, manufactured by Unitika Ltd.).

As the cationic amine-based resin (cationic polymer), any resin having an amino group in the structure may be used, and known ones can be appropriately selected and used. Examples thereof include polyamine resin, polyamide resin, polyallylamine resin, and the like. Polyamine resin is a resin having an amino group in the main skeleton of the resin. Polyamide resin is a resin having an amide group in the main skeleton of the resin. Polyallylamine resin is a resin having a structure derived from an allyl group in the main skeleton of the resin.

In addition, as the cationic polyamine-based resin, Unisense KHE103L (hexamethylenediamine/epichlorohydrin resin, 1% aqueous solution of a pH of substantially 5.0, viscosity: 20 to 50 (mPa·s), an aqueous solution with a solid content concentration of 50% by mass) manufactured by Senka Co., Ltd., Unisense KHE104L (dimethylamine/epichlorohydrin resin, 1% aqueous solution of a pH of substantially 7.0, viscosity: 1 to 10 (mPa·s), an aqueous solution with a solid content concentration of 20% by mass), and the like can be used. In addition, specific examples of commercially available products of the cationic polyamine-based resin include FL-14 (manufactured by SNF Co. Ltd.), ARAFIX 100, 251S, 255, and 255LOX (manufactured by Arakawa Chemical Industries, Ltd.), DK-6810, 6853, and 6885; and WS-4010, 4011, 4020, 4024, 4027, and 4030 (manufactured by Seiko PMC Corporation), Papiogen P-105 (manufactured by Senka), Sumirez Resin 650 (30), 675A, 6615, and SLX-1 (manufactured by Taoka Chemical Co., Ltd.), Catiomaster (registered trademark) PD-1, 7, 30, A, PDT-2, PE-10, PE-30, DT-EH, EPA-SK01, and TMHMDA-E (manufactured by Yokkaichi Chemical Company, Limited), and Jetfix 36N, 38A, 5052 (manufactured by Satoda Kako Co., Ltd.).

Examples of the polyamine-based resin include a polyallylamine resin. Examples of the polyallylamine resin include polyallylamine hydrochloride, polyallylamineamide sulfate, allylamine hydrochloride/diallylamine hydrochloride copolymers, allylamine acetate/diallylamine acetate copolymers, allylamine acetate/diallylamine acetate copolymers, allylamine hydrochloride/dimethylallylamine hydrochloride copolymers, allylamine/dimethylallylamine copolymers, polydiallylamine hydrochloride, polymethyldiallylamine hydrochloride, polymethyldiallylamineamide sulfate, polymethyldiallylamine acetate, polydiallyldimethylammonium chloride, diallylamine acetate/sulfur dioxide copolymers, diallylmethylethylammonium ethylsulfate/sulfur dioxide copolymers, methyldiallylamine hydrochloride/sulfur dioxide copolymers, diallyldimethylammonium chloride/sulfur dioxide copolymers, and diallyldimethylammonium chloride/acrylamide copolymers.

Examples of the cationic surfactant include primary, secondary, and tertiary amine salt type compounds, alkylamine salts, dialkylamine salts, aliphatic amine salts, benzalconium salts, quaternary ammonium salts, quaternary alkylammonium salt, alkylpyridinium salt, sulfonium salt, phosphonium salt, onium salt, and imidazolinium salt.

A plurality of types of these aggregating agents may be used. In addition, among these aggregating agents, when at least one of a polyvalent metal salt, an organic acid, and a cationic polymer is selected, the aggregation action of the pigment and the resin particles is more favorable, and thus an image with a higher quality (particularly favorable color developability) can be formed.

Although the total content of the aggregating agent in the reaction liquid composition is not particularly limited, the total content of the aggregating agent in the reaction liquid composition is, for example, 0.1% by mass or more and 15% by mass or less, preferably 1% by mass or more and 10% by mass or less, and more preferably 2% by mass or more and 10% by mass or less, with respect to the total mass of the reaction liquid composition.

### 1.3.1. 2 Other Components

The reaction liquid composition may include water, a moisturizing agent, a polyhydric alcohol, other solvents, a surfactant, and an additive. Among these, water, the moisturizing agent, other solvents, the surfactant, and the additive are the same as those of the above-described ink composition, and thus the description thereof will be omitted.

The reaction liquid composition preferably contains a polyhydric alcohol among the other solvents described above. In addition, when the reaction liquid composition contains a polyhydric alcohol, the content of the polyhydric alcohol in the reaction liquid composition is preferably 70% by mass or more, more preferably 80% by mass or more, and even more preferably 85% by mass or more with respect to the total amount of the organic solvent in the reaction liquid composition. Thus, since the permeability of the polyhydric alcohol is low, the reaction liquid composition can more easily remains in the vicinity of the fabric surface, and the color developability of the image can be further improved.

In the reaction liquid composition, the content of the coloring material is preferably 0.1% by mass or less with respect to the total amount of the reaction liquid composition. That is, it is preferable that the reaction liquid composition is not used with the intention of coloring.

### 1.3.1. 3 Physical Properties and Manufacturing of Reaction Liquid Composition

When the reaction liquid composition is attached to the recording medium by an ink jet method, the viscosity of the reaction liquid composition at 20° C. is preferably 1.5 mPa·s or more and 15 mPa·s or less, more preferably 1.5 mPa·s or more and 7 mPa·s or less, and even more preferably 1.5 mPa·s or more and 5.5 mPa·s or less. When the reaction liquid composition is attached to the recording medium by the ink jet method, it is easy to efficiently form a predetermined image on the recording medium.

The surface tension of the reaction liquid composition at 25° C. is 40 mN/m or less, preferably 38 mN/m or less, and more preferably 35 mN/m or less from a viewpoint of obtaining appropriate wet spreadability on the recording medium. In addition, the surface tension is preferably 20 mN/m or more, and more preferably 25 mN/m or more.

The surface tension can be measured by confirming the surface tension when a platinum plate is wetted with the composition in an environment of 25° C. using an automatic surface tensiometer CBVP—Z (manufactured by Kyowa Interface Science, Co., Ltd.).

The reaction liquid composition is obtained by mixing the components described above in an arbitrary order and, as necessary, carrying out filtration or the like to remove impurities. As a method of mixing each component, a method of sequentially adding materials to a container equipped with a stirring device such as a mechanical stirrer and a magnetic stirrer, and performing stirring and mixing is suitably used. As a filtration method, centrifugal filtration, filter filtration, and the like can be performed as necessary.

### 1.3.2. Method of Attaching Reaction Liquid Composition to Fabric

The reaction liquid attachment step may be performed by any method provided that an ink jet method having a form in which the reaction liquid composition is attached to the recording medium while an ink jet head scans the recording medium is used. In the ink jet method, main scanning is performed a plurality of times for recording by moving the ink jet head in a direction perpendicular to a transport direction of the recording medium. Although the details will be described later, the ink composition and the reaction liquid composition are attached to the same scanning region of the fabric by the same main scanning.

The reaction liquid attachment step is performed such that the attachment amount of the polyvalent metal salt in the reaction liquid composition to the recording medium is 0.3 (mg/inch²) or more. The attachment amount of the polyvalent metal salt to the recording medium in the reaction liquid attachment step is more preferably 0.5 (mg/inch²) or more, and even more preferably 0.9 (mg/inch²) or more. With such an attachment amount, even when the ink composition and the reaction liquid composition are attached to the same scanning region of the recording medium by the same main scanning, the ink composition or other composition components can be favorably aggregated, and color developability can be improved.

On the other hand, the attachment amount of the polyvalent metal salt is preferably 1.7 (mg/inch²) or less, more preferably 1.5 (mg/inch²) or less, and even more preferably 1.0 (mg/inch²) or less. In this manner, the color developability of an image can be further improved.

In addition, the upper limit is preferably 25.0 (mg/inch²) or less, more preferably 18.0 (mg/inch²) or less, and even more preferably 15.0 (mg/inch²) or less.

The attachment amount of the reaction liquid composition described above is applied in the recording region where the reaction liquid composition and ink composition are overlapped and attached in the recording method of the present embodiment. In addition, the maximum attachment amount of the reaction liquid composition in the region may be within the above range, which is preferable.

### 1.4. Position of Nozzle Row Discharging Reaction Liquid Composition

In the ink jet recording method of the present embodiment, when the ink composition contains a self-dispersing pigment as the pigment, the arrangement of the nozzle rows that discharge the ink composition will be described. Since the self-dispersing pigment has a high aggregation rate due to the aggregating agent but also has high dispersion stability, as a result, the aggregation effect (easiness of forming coarse particles that affect the discharge) of the reaction liquid composition by the aggregating agent is smaller than that of a resin dispersed pigment. Therefore, the ink composition using the self-dispersing pigment is less likely to cause aggregation due to mist even when the reaction liquid composition is discharged from the nozzle row positioned close to the nozzle row from which the reaction liquid composition is discharged.

In the above-described example in FIG. 1, from this viewpoint, it is preferable that the ink composition using the self-dispersing pigment is discharged from the second nozzle row 102 and the fifth nozzle row 105. That is, even when the reaction liquid composition is discharged from the third nozzle row 103 and the fourth nozzle row 104 or even when the reaction liquid composition is discharged from the first nozzle row 101 and the sixth nozzle row 106, it is preferable that the reaction liquid composition is discharged from the second nozzle row 102 and the fifth nozzle row 105, which are adjacent nozzle rows.

In this manner, since the nozzle row that discharges the ink composition including the self-dispersing pigment is adjacent to the nozzle row that discharges the reaction liquid composition, the compositions that are much less likely to cause aggregation due to mist are adjacent to each other, and thus the discharge reliability can be improved. In addition, even in a case in which aggregates are formed, the aggregates of the self-dispersing pigment are easily re-dissociated, and thus the waste liquid consumption at the time of cleaning can be suppressed.

On the other hand, a case in which the ink composition contains only a resin dispersed pigment as the pigment will be described. In this case, it is preferable that the ink composition is discharged from the nozzle row separated from the nozzle row in which the reaction liquid composition is discharged.

In the above-described example in FIG. 1, from this point of view, when the reaction liquid composition is discharged from the third nozzle row 103 and the fourth nozzle row 104, it is preferable that the ink composition using only the resin dispersed pigment as the pigment is discharged from the first nozzle row 101 and the sixth nozzle row 106.

In addition, in the above-described example in FIG. 1, from the same viewpoint, when the reaction liquid composition is discharged from the first nozzle row 101 and the sixth nozzle row 106, it is preferable that the ink composition using only the resin dispersed pigment as the pigment is discharged from the third nozzle row 103 and the fourth nozzle row 104.

In this manner, since the nozzle row that discharges the ink composition containing only the resin dispersed pigment that more easily forms aggregates when coming into contact with the reaction liquid composition can be arranged away from the nozzle row that discharges reaction liquid composition, aggregation due to mist is less likely to occur, and the reliability can be further improved.

### 1.5. Other Steps

### 1.5.1. Clear Ink Attachment Step

The ink jet recording method according to the present embodiment may include a clear ink attachment step. In the clear ink attachment step, a clear ink composition containing resin particles is discharged by an ink jet method and attached to the recording medium.

### 1.5.1. 1 Clear Ink Composition

The clear ink composition contains resin particles (resin dispersion).

### 1.5.1. 1-1 Resin Particle

Since the resin particles are the same as the resin particles which may be contained in the above-described ink composition, the description thereof will be omitted. When the ink jet recording method includes the clear ink attachment step and the reaction liquid composition and the clear ink composition come into contact with each other, the resin particles contained in the clear ink composition are easily aggregated and are less likely to be sunk inside the recording medium, and thus the rubbing fastness of an image to be obtained is further improved.

### 1.2.1. 1-2 Other Components

The clear ink composition may contain other components. The other components are the same as described in “1.1.1. 3 Other components”, and the description thereof will be omitted.

In the clear ink composition, the content of the coloring material is preferably 0.1% by mass or less with respect to the total amount of the clear ink composition. That is, it is preferable that the clear ink composition is not used for the intention of coloring.

### 1.5.1. 1-3 Manufacturing and Physical Properties

When the clear ink composition is attached to the fabric by an ink jet method, the viscosity thereof at 20° C. is preferably 1.5 mPa·s or more and 15 mPa·s or less, more preferably 1.5 mPa·s or more and 7 mPa·s or less, and even more preferably 1.5 mPa·s or more and 5.5 mPa·s or less.

The surface tension of the clear ink composition at 25° C. is 40 mN/m or less, preferably 38 mN/m or less, more preferably 35 mN/m or less, and even more preferably 30 mN/m or less from the viewpoint of ensuring appropriate wet spreadability to the fabric. In addition, the surface tension is preferably 25 mN/m or more, and more preferably 28 mN/m or more. When the surface tension of the clear ink composition is high, the clear ink composition is less likely to scatter when discharged from the nozzle, mist during discharge is less likely to occur, and thus the discharge stability can be further improved.

The clear ink composition is obtained by mixing the components described above in an arbitrary order and, as necessary, carrying out filtration or the like to remove impurities. As a method of mixing each component, a method of sequentially adding materials to a container equipped with a stirring device such as a mechanical stirrer and a magnetic stirrer, and performing stirring and mixing is suitably used. As a filtration method, centrifugal filtration, filter filtration, and the like can be performed as necessary.

### 1.5.1. 2 Attachment Form

The clear ink attachment step is performed by an ink jet method. The attachment amount of the clear ink composition in the clear ink attachment step is preferably 15 g/m² or more and 80 g/m² or less, more preferably 20 g/m² or more and 40 g/m² or less, and even more preferably 25 g/m² or more and 30 g/m² or less.

The nozzle rows for attaching the clear ink composition do not necessarily have to be arranged symmetrically to each other, but the symmetrical arrangement is preferable from the viewpoint that the recording unevenness can be further reduced. When the ink jet recording method includes the clear ink attachment step, a recorded matter having more favorable rubbing fastness can be obtained.

### 1.5.2. Step Repetition or the Like

The ink jet recording method according to the present embodiment may include a plurality of ink attachment steps. In addition, when the ink attachment step is included multiple times, the ink compositions to be attached in each ink attachment step may be the same or different. However, in this case, the nozzle rows, from which the respective ink compositions are discharged, are arranged symmetrically as described above. In addition, the same applies to the reaction liquid attachment step and the clear ink attachment step.

### 1.6. Recording Medium

The recording medium to which the ink jet recording method of the present embodiment can be applied is not particularly limited. The recording medium may or may not have a recording surface that absorbs ink. Therefore, the recording medium is not particularly limited, and examples thereof include liquid absorbing recording media such as paper, film, and fabric, liquid low-absorption recording media such as printed paper, liquid non-absorption recording media such as metal, glass, and polymers, and the like.

In the recording method of the present embodiment, the effect is more remarkable when a fabric is used among the recording media. That is, the fabric is a permeable medium, and the color development easily changes slightly on a balance between the speed at which the ink composition and reaction liquid composition mix and the components are aggregated and the speed at which the compositions permeate into the fabric. However, according to the ink jet recording method of the present embodiment, an image with less unevenness in color developability can be formed even with respect to such a fabric.

The fabric is not particularly limited. The material constituting the fabric is not particularly limited, examples thereof include natural fibers such as cotton, linen, wool, and silk, synthetic fibers such as polypropylene, polyester, acetate, triacetate, polyamide, and polyurethane, and biodegradable fibers such as polylactic acid, and blended fibers thereof may be used. As the fabric, the fibers listed above may be in any form such as a woven fabric, a knitted fabric, and a nonwoven fabric, and may be blended or woven.

As the fabric, the fiber may be any form of a woven fabric, a knitted fabric, a nonwoven fabric, and the like. In addition, the basis weight of the fabric used in the present embodiment is not particularly limited, and may be 1.0 oz or more and 10.0 oz or less, preferably 2.0 oz or more and 9.0 oz or less, more preferably 3.0 oz or more and 8.0 oz or less, and even more preferably 4.0 oz or more and 7.0 oz or less. When the basis weight of the fabric is within such a range, favorable recording can be performed. In addition, in the textile printing recording method according to the present embodiment, a plurality of types of fabrics having different basis weights can be applied, and favorable printing can be performed.

In the present embodiment, examples of the form of the fabric include cloth, garment and other clothing ornaments, and the like. The cloth includes a woven fabric, a knitted fabric, a nonwoven fabric, and the like. Garment and other clothing ornaments include sewn T-shirts, handkerchiefs, scarves, towels, handbags, and fabric furniture such as bags, curtains, sheets, bedspreads, and wallpaper, cloth before and after cutting as parts to be sewn, and the like. Examples of these forms include a long roll-shaped product, a product cut into a predetermined size, and a product having the shape of a manufactured product.

Further, as the fabric, a cotton fabric pre-colored with a dye may be used. Examples of dyes with which the fabric is pre-colored include water-soluble dyes such as acidic dyes and basic dyes, disperse dyes used in combination with dispersants, and reactive dyes. When the cotton fabric is used as the fabric, a reactive dye suitable for dyeing cotton is preferably used.

### 1.7. Action and Effect

According to the ink jet recording method of the present embodiment, the productivity can be increased by performing recording respectively by bidirectional carriage scanning. Further, according to this ink jet recording method, by symmetrically arranging the ink composition and the reaction liquid composition discharged from the nozzles, the attachment order of the ink composition and the reaction liquid composition is the same in the forward pass and the return pass, and thus the image quality (permeation unevenness, streaks) and color developability of the recorded matter can be improved. Further, according to this ink jet recording method, by adopting a configuration of an independent head in which only the reaction liquid composition is discharged from the ink jet head that discharges the reaction liquid composition, the distance from the nozzle row that discharges the ink composition is increased to reduce the effect of mist, and the waste liquid system can be separated for the reaction liquid composition and the ink composition. Thus, the reliability of the waste liquid system can also be improved.

### 2. Ink Jet Recording Apparatus

An example of an ink jet recording apparatus that can carry out the ink jet recording method according to the present embodiment will be described. The ink jet recording apparatus is an ink jet recording apparatus including a carriage in which a first nozzle row, a second nozzle row, a third nozzle row, a fourth nozzle row, a fifth nozzle row, and a sixth nozzle row extending in a sub-scanning direction in which a recording medium is transported are arranged in this order in a main scanning direction intersecting the sub-scanning direction, in which recording is performed by performing reciprocating scanning in the main scanning direction, and discharging a first composition, a second composition, a third composition, a fourth composition, a fifth composition, and a sixth composition from the first nozzle row, the second nozzle row, the third nozzle row, the fourth nozzle row, the fifth nozzle row, and the sixth nozzle row, respectively, in both a forward pass and a return pass.

Further, the nozzle rows are arranged such that a distance between the first nozzle row and the third nozzle row in the main scanning direction is equal to a distance between the fourth nozzle row and the sixth nozzle row in the main scanning direction, and a distance between the second nozzle row and the third nozzle row in the main scanning direction is equal to a distance between the fourth nozzle row and the fifth nozzle row in the main scanning direction.

In addition, the first composition and the sixth composition are set to the same composition, and the second composition and the fifth composition are set to be the same composition, and the third composition and the fourth composition are set to be the same composition. Further, any one of the first composition, the second composition, and the third composition is a reaction liquid composition containing an aggregating agent, and nozzle rows that discharge a composition corresponding to the reaction liquid composition among the first composition, the second composition, and the third composition are provided in each or one independent ink jet head.

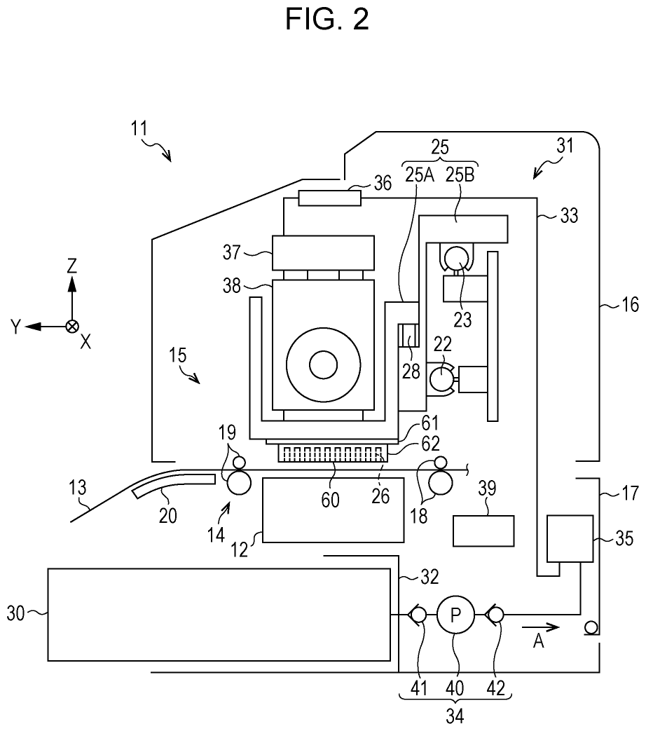

FIG. 2 is a schematic cross-sectional view of a printer 11 which is an example of the ink jet recording apparatus that can carry out the ink jet recording method of the present embodiment. The printer 11 shown in FIG. 2 is an ink jet recording apparatus including a support base 12, a transport portion 14, a print portion 15, a printer main body 16, and a cover 17. The support base 12, the transport portion 14, and the print portion 15 are assembled to the printer main body 16 which is configured by a housing, a frame, or the like. Further, the cover 17 is openably and closably attached to the printer main body 16.

The support base 12 extends in the width direction of a recording medium 13, that is, in the X-axis direction in FIG. 2. The transport portion 14 transports the recording medium 13 supported by the support base 12 in the Y-axis direction, which is a transport direction, along the surface of the support base 12. The print portion 15 ejects ink onto the transported recording medium 13 to perform printing.

In addition, the transport portion 14 includes transport roller pairs 18 and 19 and a guide plate 20. The transport roller pair 18 is arranged on the upstream of the support base 12 in the transport direction of the recording medium 13, and the transport roller pair 19 is arranged on the downstream. The guide plate 20 is arranged on the downstream of the transport roller pair 19 in the transport direction and guides the recording medium 13 while supporting the recording medium 13. Then, the transport roller pairs 18 and 19 are driven by a transport motor (not shown) to rotate while interposing the recording medium 13 therebetween. Therefore, the transport portion 14 transports the recording medium 13 in the Y-axis direction along the surface of the support base 12 and the surface of the guide plate 20.

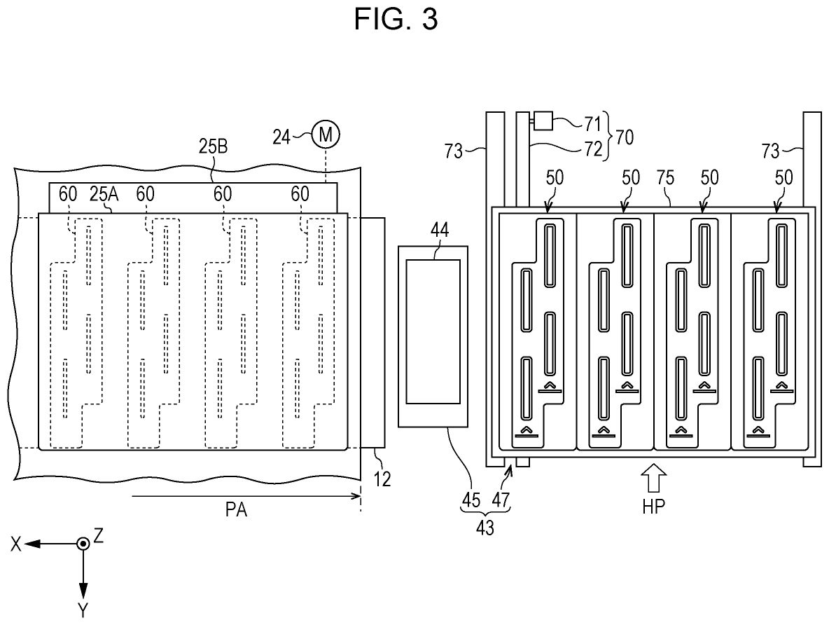

The print portion 15 includes guide shafts 22 and 23 extending in the X-axis direction, and a carriage 25 that can reciprocate in the X-axis direction while being guided by the guide shafts 22 and 23. The carriage 25 has a carriage base 25B and a carriage main body 25A. The carriage base 25B reciprocates in the X-axis direction as the carriage motor 24 shown in FIG. 3 is driven. The carriage main body 25A is slid and moved in a Z-axis direction so that a distance from the support base 12 is changed with respect to the carriage base 25B. That is, the carriage main body 25A can move in the Z-axis direction with respect to the carriage base 25B by a moving mechanism 28 configured by a cam or the like.

At least three ink jet heads 60 are attached to the carriage main body 25A. In the present embodiment, four ink jet heads 60 are attached. In FIG. 3, the four ink jet heads 60 are arranged at a constant pitch in the X-axis direction. Each ink jet head 60 has nozzles 26 shown in FIG. 2 that can eject the composition. Each ink jet head 60 is supported by the carriage main body 25A so that the lower surface thereof faces the support base 12 at a predetermined interval in the Z-axis direction, and reciprocates in the X-axis direction together with the carriage 25 as the carriage motor 24 is driven.

A part of a supply mechanism 31 is attached to the carriage 25. The supply mechanism 31 supplies the composition to the ink jet head 60 from the ink cartridge 30. Specifically, the supply mechanism 31 causes ink to flow in a supply direction A from an ink cartridge 30 side (upstream) to the ink jet head 60 side (downstream). The ink cartridge 30 and the supply mechanism 31 are provided with at least one set for each type of composition. In the present embodiment, since eight colors of ink are used, eight sets of the ink cartridge 30 and the supply mechanism 31 are provided. The number of compositions included in the printer 11 is not particularly limited as long as the compositions are two or more.

The eight ink cartridges 30 store different types of compositions, and each ink cartridge is freely detachably attached to a mounting portion 32. By ejecting the composition supplied from each ink cartridge 30 from the ink jet heads 60, color printing or the like is performed on the recording medium 13.

Each supply mechanism 31 includes a supply path 33 that supplies the composition from the ink cartridge 30 to the ink jet head 60. A supply pump 34 that causes the composition to flow, a filter unit 35 that captures air bubbles and foreign matter in the ink, a static mixer 36 that stirs the composition by changing the flow of the ink which flows along the supply path 33, a liquid retaining chamber 37 that retains the composition, and a pressure adjustment unit 38 that adjusts the composition pressure are provided on the supply path 33 in this order from the upstream in the supply direction A.

The supply pump 34 has a diaphragm pump 40 of a pump chamber having a variable volume, a suction valve 41 that is arranged on the upstream of the diaphragm pump 40, and a discharge valve 42 that is arranged on the downstream of the diaphragm pump 40. The suction valve 41 and the discharge valve 42 are one-way valves that allow the flow of the composition to the downstream and block flow of the composition to the upstream.

Therefore, the supply pump 34 sucks the composition from the ink cartridge 30 side through the suction valve 41 as the volume of the pump chamber of the diaphragm pump 40 increases, and the composition is discharged to the ink jet head 60 side through the discharge valve 42 as the volume of the pump chamber decreases. Further, the filter unit 35 is arranged at a position corresponding to the cover 17 of the printer main body 16 and is detachably attached to the supply path 33. Then, the filter unit 35 can be replaced by opening the cover 17.

In the printer 11, printing is performed on the recording medium 13 by repeating a printing operation in which the composition is ejected from each nozzle 26 of the ink jet head 60 in the middle of the carriage 25 moving in the positive direction on the X axis to perform recording for forward scanning on the recording medium 13, a printing operation in which the composition is ejected from each nozzle 26 of the ink jet head 60 in the middle of the carriage 25 moving in the X-axis negative direction to perform recording for return scanning on the recording medium 13, and a transport operation in which the recording medium 13 is transported to the next printing position.

The printer 11 includes a control portion 39 that controls a printing operation and a transport operation. The control portion 39 controls the drive of the transport motor (not shown) that drives the transport roller pairs 18 and 19, the carriage motor 24, the supply pump 34, and the like, and controls the discharge of the ink from each nozzle 26 of the ink jet head 60. The ink jet head 60 ejects the composition to be supplied from each nozzle 26 onto the recording medium 13 while reciprocating together with the carriage 25 in the X-axis direction as the carriage motor 24 is driven. Further, the control portion 39 operates the moving mechanism 28 to vertically move the carriage main body 25A according to the thickness of the recording medium 13, for example.

The recording medium 13 is not particularly limited, and examples thereof include various papers, various films, various fabrics, and the like. The material constituting the fabric is not particularly limited, and examples thereof may include natural fibers such as cotton, linen, wool, and silk, synthetic fibers such as polypropylene, polyester, acetate, triacetate, polyamide, and polyurethane, and biodegradable fibers such as polylactic acid, and blended fibers thereof. As the fabric, the fibers listed above may be in any form such as a woven fabric, a knitted fabric, and a non-woven fabric.

FIG. 3 is a plan view schematically showing the positional relationship between the support base, the ink jet head, and a maintenance mechanism included in the printer in FIG. 2. As shown in FIG. 3, a maintenance mechanism 43 is provided at a position adjacent to one end of the support base 12 in the X-axis direction. The maintenance mechanism 43 maintains the ink jet head 60. In the present embodiment, the region in which the recording medium 13 is transported is referred to as a transport region PA shown in FIG. 3. The maintenance mechanism 43 is arranged within a scanning region of the carriage 25 in the X-axis direction and outside the transport region PA. In FIG. 3, the maintenance mechanism 43 is arranged on the right side of the transport region PA.

When the printing is not performed or when power is turned off, the carriage 25 and the ink jet head 60 stand by at a home position HP where the maintenance mechanism 43 is arranged. The ink jet head 60 is movable between the transport region PA and the home position HP in the X-axis direction.

The maintenance mechanism 43 includes a flushing unit 45 and a cleaning mechanism 47 that are arranged in order from a position close to the transport region PA in the X-axis direction.

The flushing unit 45 has a liquid receiving portion 44. The liquid receiving portion 44 receives the composition ejected from the nozzle 26. Such a flushing unit 45 receives the composition ejected from each nozzle 26 unrelated to printing for the purpose of preventing or eliminating clogging and the like of each nozzle 26. In this manner, flushing can be performed. Further, the cleaning mechanism 47 performs a cleaning operation on the ink jet head 60.

The cleaning mechanism 47 includes a unit holder 75 and four maintenance units 50 attached to the unit holder 75. The maintenance units 50 face the ink jet heads 60 standing by at the home position HP, respectively, and perform maintenance. In addition, the cleaning mechanism 47 includes a pair of guide frames 73 that guide the movement of the unit holder 75 in the Y-axis direction, and a holder driving portion 70 that causes the unit holder 75 to reciprocate in the Y-axis direction. The guide frame 73 and the holder driving portion 70 are assembled to the printer main body 16, respectively.

The holder driving portion 70 shown in FIG. 3 includes an electric motor 71 as a power source and a belt 72. The unit holder 75 is fixed to the belt 72, and the electric motor 71 is rotationally driven, so that the belt 72 revolves. The unit holder 75 is guided on both sides in the X-axis direction by the guide frames 73, and reciprocates in the Y-axis direction along the circumference of the belt 72. The drive of the electric motor 71 is controlled by the control portion 39.

The four maintenance units 50 are guided by at least one of both side walls of the unit holder 75 in the X-axis direction and both side walls in the Y-axis direction, are integrated with each other, and are moved to change a distance with the facing ink jet heads 60 changes.

As shown in FIG. 2, the ink jet head 60 includes a bracket portion 61 for attachment to the carriage 25, and a head main body portion 62 protruding downward from the bracket portion 61.

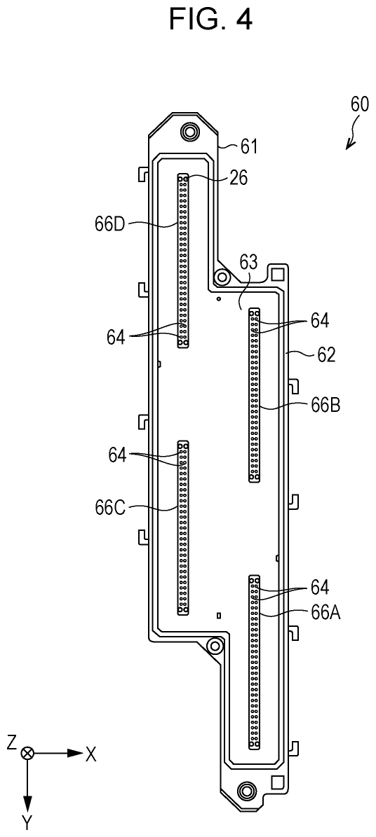

FIG. 4 is a plan view of the ink jet head shown in FIG. 2. As shown in FIG. 4, on the lower surface of the head main body portion 62, a plate-shaped cover member 63 in which four through-holes 66A, 66B, 66C, and 66D are provided is fixed to the head main body portion 62 by a fixing structure such as a lock. Each of the four through-holes 66A, 66B, 66C, and 66D exposes two nozzle rows 64. The nozzle rows 64 are a collection of the nozzles 26 that are arranged at a constant pitch. The number of nozzle rows 64 is not limited to two, and may be three or more.

In the above-described ink jet recording method, the two nozzle rows 64 can be assigned as, for example, the first nozzle row 101 and the second nozzle row 102, respectively. As in the example shown in FIG. 3, when three or more ink jet heads 60 are provided, the first to sixth nozzle rows can be assigned according to the conditions.

In the present embodiment, the through-hole 66A and the through-hole 66B are arranged in this order from the Y-axis positive side to the Y-axis negative side. Then, the nozzle row 64 exposed in the through-hole 66A and the nozzle row 64 exposed in the through-hole 66B are arranged in a row along the Y axis.

In the present embodiment, the through-hole 66C and the through-hole 66D are arranged in this order from the Y-axis positive side to the Y-axis negative side. The nozzle row 64 exposed in the through-hole 66C and the nozzle row 64 exposed in the through-hole 66D are arranged in a row along the Y axis.

Further, the through-holes 66A and 66B and the through-holes 66C and 66D are arranged at predetermined intervals in the X-axis direction. Further, the through-hole 66B is arranged at an intermediate position between the through-hole 66C and the through-hole 66D in the Y-axis direction. Similarly, the through-hole 66C is arranged at an intermediate position between the through-hole 66A and the through-hole 66B in the Y-axis direction.

The entire lower surface of the ink jet head 60 as described above is an object to be wiped by the maintenance unit 50.

As shown in FIG. 4, the nozzle row 64 includes a large number of nozzles 26 arranged at a constant pitch along the Y axis. Each nozzle row 64 discharges a composition corresponding to the composition of the ink cartridge 30. An unused nozzle row in which ink is not ejected may be present among the plurality of nozzle rows 64.

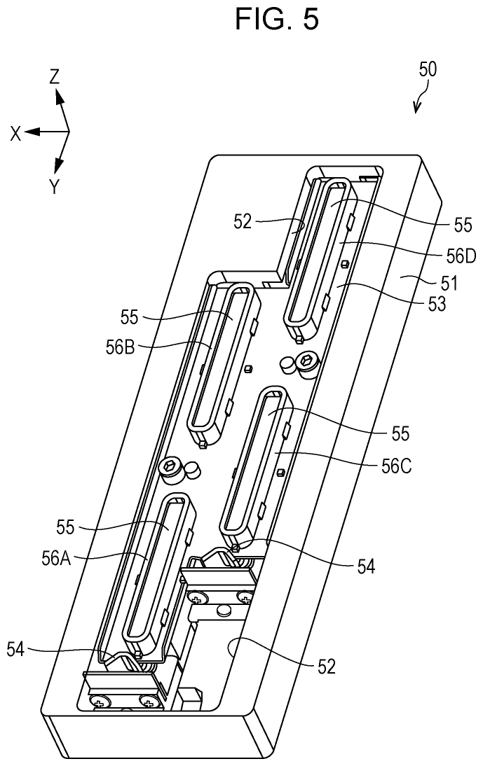

The four maintenance units 50 have the same configuration as each other. FIG. 5 is a perspective view of the maintenance unit 50 shown in FIG. 3. The maintenance unit 50 shown in FIG. 5 includes a unit frame body 51 having a bottomed box shape having an opening portion 52 on an upper surface thereof. In the unit frame body 51, an absorbing member 55 that can absorb the composition and a wiping member 54 that can wipe the ink jet head 60 are accommodated so as to be adjacent to each other in the Y-axis direction. The opening portion 52 is configured such that the head main body portion 62 is accommodated inside the opening portion 52 when viewed from the Z-axis direction in a state where the ink jet head 60 faces the maintenance unit 50.

The absorbing member 55 shown in FIG. 5 is provided in caps 56A, 56B, 56C, and 56D provided in the unit frame body 51. The caps 56A, 56B, 56C, and 56D have a cylindrical side wall with an oval upper surface. Then, the caps 56A, 56B, 56C, and 56D are fixed in the unit frame body 51 by a fixing plate 53 so that the through-holes 66A, 66B, 66C, and 66D are positioned inside the cylindrical side wall in a state where the ink jet head 60 faces the maintenance unit 50.

The wiping members 54 shown in FIG. 5 are respectively provided at two locations on the Y-axis positive side of the cap 56A and the Y-axis positive side of the cap 56C. The wiping member 54 is formed of a thin plate-shaped rubber member, and the rubber member is an elastic member having a lower ability to absorb ink than the absorbing member 55.

Next, the maintenance operation of the ink jet head 60 by the maintenance unit 50 will be described. This maintenance operation is controlled by the control portion 39, and herein, a contact operation and a wiping operation are performed. The maintenance unit 50 performs the maintenance operation on the through-holes 66C and 66D at the same time as the maintenance operation on the through-holes 66A and 66B. Therefore, in the following description, the maintenance operation performed with respect to the through-holes 66A and 66B will be described as an example.

First, the contact operation will be described. By driving the carriage motor 24, the carriage 25 is moved in the X-axis direction, and the ink jet head 60 is brought into a state of facing the maintenance unit 50. From this state, the ink jet head 60 is lowered by the moving mechanism 28, and the maintenance unit 50 is raised by a driving portion (not shown).

Next, the pressure of the ink supplied to the ink jet head 60 is adjusted by the pressure adjustment unit 38 to cause the composition to swell from the nozzle 26. In the contact operation, the absorbing member 55 is brought into contact with the composition caused to swell from the ink jet head 60.

Next, the wiping operation will be described. Although the composition swelling from the nozzle 26 due to the contact operation described above is absorbed by the absorbing member 55, there may be a remaining composition remaining around the nozzle 26 without being absorbed. Therefore, as the maintenance operation, after the contact operation, a wiping operation of wiping to remove the remaining composition is performed.

In the wiping operation, a direction from the Y-axis positive side to the Y-axis negative side is defined as a wiping direction, and the maintenance unit 50 is moved in this wiping direction. By moving the maintenance unit 50, the wiping member 54 provided in the maintenance unit 50 wipes the lower surface of the ink jet head 60. By the wiping operation, the remaining composition attached to the periphery of the nozzles 26 of the nozzle row 64 is removed from the periphery of the nozzles 26.

Following the wiping operation, a flushing operation of forcibly ejecting the composition from the nozzle 26 may be performed regardless of printing.

In the flushing operation, the composition is ejected from each nozzle 26 of the ink jet head 60 toward the absorbing member 55 in a state where the ink jet head 60 faces the maintenance unit 50.

After the flushing operation is ended, the ink jet head 60 is raised by the moving mechanism 28, and the maintenance unit 50 is lowered by the driving portion (not shown) to return the position to the position before the start of the contact operation. Accordingly, the maintenance operation of the ink jet head 60 by the maintenance unit 50 is ended.

In the present embodiment, when the reaction liquid composition is set to be discharged from any of the nozzle rows 64, the nozzle rows 64 belonging to the ink jet head 60 are all nozzle rows that discharge the reaction liquid composition. Therefore, the composition ejected from each nozzle 26 in the ink jet head 60 is less likely to aggregate the components in the liquid receiving portion 44 or the waste liquid pipe (not shown). In addition, even in another ink jet head 60 that does not have the nozzle row 64 discharging the reaction liquid composition, the composition ejected from each nozzle 26 is less likely to cause aggregation of the components in the corresponding liquid receiving portion 44 or the waste liquid pipe (not shown).

According to the above-described ink jet recording apparatus (printer), the productivity can be increased by performing recording respectively by bidirectional carriage scanning. Further, according to this ink jet recording apparatus, by symmetrically arranging the ink composition and the reaction liquid composition discharged from the nozzles, the attachment order of the ink composition and the reaction liquid composition is the same in the forward pass and the return pass, and thus the image quality (permeation unevenness, streaks) and color developability of the recorded matter can be improved. Further, according to this ink jet recording apparatus, by adopting a configuration of an independent head in which only the reaction liquid composition is discharged from the ink jet head that discharges the reaction liquid composition, the distance from the nozzle row that discharges the ink composition is increased to reduce the effect of mist, and the waste liquid system can be separated for the reaction liquid composition and the ink composition. Thus, the reliability of the waste liquid system can also be improved.

### 3. Examples and Comparative Examples

Hereinafter, the present disclosure will be specifically described with reference to Examples, and the present disclosure is not limited to these Examples. Hereinafter, “part” and “%” are based on mass unless otherwise specified. Unless otherwise specified, the evaluation was performed in an environment of a temperature of 25° C. and a relative humidity of 40.0%.

### 3.1. Preparation of Each Composition

The reaction liquid composition, the ink composition, and the clear ink composition were prepared as follows.

Each component was placed in a container so as to have the composition shown in Table 1, mixed and stirred with a magnetic stirrer for 2 hours, and then filtered through a membrane filter having a pore size of 5 μm to obtain reaction liquid compositions, ink compositions, and clear ink compositions used in Examples and Comparative Examples. The numerical values in the table represent the solid content.

As the self-dispersing pigment and resin dispersed pigment, the following were used.

### Self-Dispersing Pigment

A Bonjetblack CW-1 (manufactured by Orient Chemical Industries Co., Ltd.) pigment dispersion liquid was used. Resin Dispersed Pigment
A C. I. Pigment Blue 15:3 (manufactured by Dainichiseika Color & Chemicals Mfg. Co., Ltd.) pigment dispersion liquid was used (in the table, “PB-15:3”).

The abbreviations and trade names shown in Table 1 are supplemented.
Unisense FPA100L: poly(diallyldimethylammonium chloride) aqueous solution, manufactured by Senka Co., Ltd.
TAKELAK W-6061: urethane-based resin emulsion, manufactured by Mitsui Chemicals, Inc.
E1010: OLFINE E1010, acetylenic glycol-based surfactant, manufactured by Nissin Chemical Industry Co., Ltd.

### 3.2. Evaluation Method

### 3.2.1. Preparation of Recorded Matter

Print evaluation was performed using a modified machine of ML-8000.

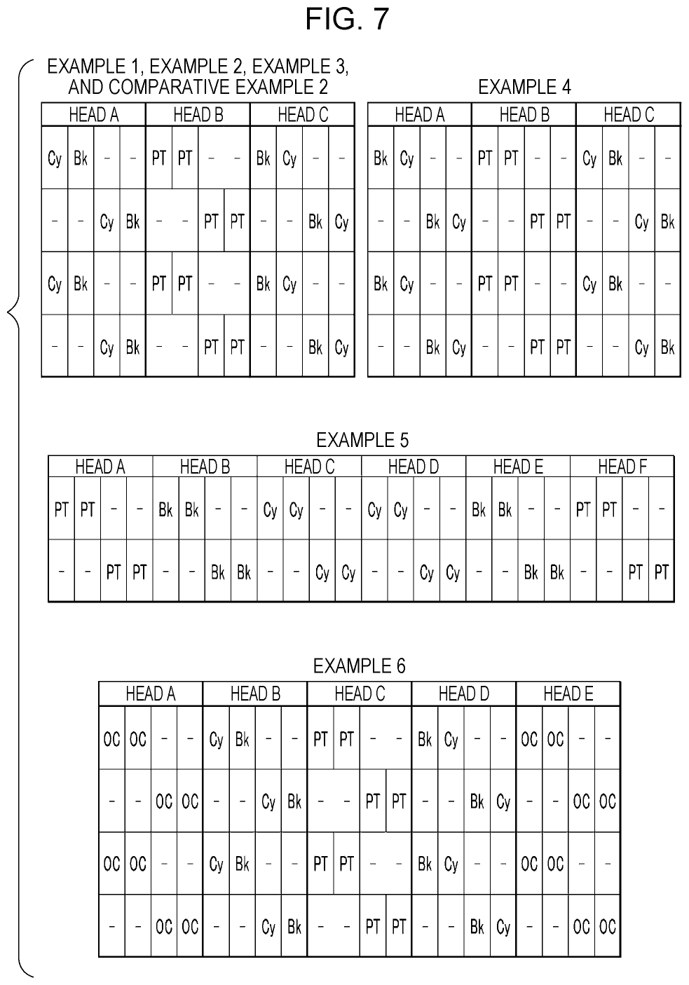

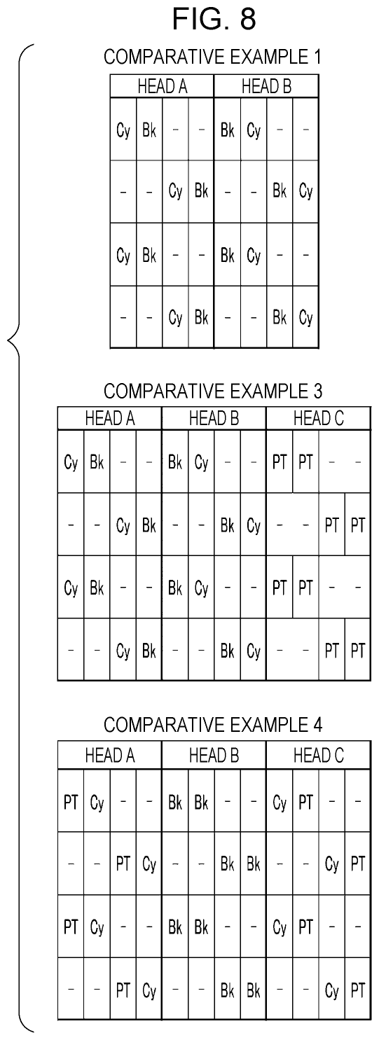

The head arrangement was modified as necessary as in Examples and Comparative Examples shown in FIGS. 7 and 8, and the evaluation was performed. FIGS. 7 and 8 show the composition discharged by each nozzle row in an example in which one ink jet head has eight nozzle rows, excluding Example 5. In Example 5, one ink jet head has four nozzle rows and compositions discharged by each nozzle row are shown.

In FIGS. 7 and 8, PT represents any one of PT1, PT2 and PT3 in Table 1, Bk represents Bk in Table 1, Cy represents Cy in Table 1, and OC represents OC in Table 1. In addition, in FIGS. 7 and 8, the nozzle row is not arranged in the portion denoted by “-”. As an example, in the case of the drawings of Example 1, Example 2, Example 3, and Comparative Example 2 in FIG. 7, in each of three ink jet heads of ink jet heads A to C, two rows of nozzle rows and four rows in the sub-scanning direction, for a total of eight nozzle rows, are arranged, and the compositions shown in the drawing are discharged.

As an example, in the case of the drawings of Example 1, Example 2, Example 3, and Comparative Example 2 in FIG. 7, all of the four nozzle rows are symmetrical about the second column “PT” when viewed in the main scanning direction. Further, the head B that discharges PT is one independent ink jet head.

Recorded matter of each example was prepared under the conditions shown in FIGS. 7 and 8 and Table 2.

### 3.2.2. Evaluation of Color Developability

With respect to the recorded matter of each example, the color developability of Bk was evaluated by measuring the OD value. The recorded matter whose recording conditions were 1200×600 dpi, a PT Duty of 100%, a Bk Duty of 100%, and a Cy Duty of 100% was dried at 160° C. for 3 minutes, and then the OD value after drying was measured to perform evaluation according to the following evaluation criteria. The results are shown in Table 2.
A: OD value of 1.5 or more
B: OD value of 1.4 or more and less than 1.5
C: OD value of less than 1.4

### 3.2.3. Evaluation of Image Quality (Permeation Unevenness and Streaks)

With respect to the recorded matter of each example, the color developability of Bk was evaluated by measuring the OD value. The recorded matter whose recording conditions were 1200×600 dpi, a PT Duty of 100%, a Bk Duty of 100%, and a Cy Duty of 100% was dried at 160° C. for 3 minutes, and the recorded matter after drying was evaluated visually according to the following criteria.
A: Unevenness cannot be visually recognized.
B: Unevenness is visible but improved by increasing the number of passes.
C: The unevenness is visible, and there is no improvement even when the number of passes is increased.

### 3.2.4. Evaluation of Productivity

For each example, the printing speed when continuous printing was performed under the conditions of 1200×600 dpi, a PT Duty of 100%, a Bk Duty of 100%, and a Cy Duty of 100% was calculated. Determination was performed according to the following criteria.
A: Printing speed of 60 m²/h or higher
C: Printing speed of lower than 50 m²/h

### 3.2.5. Evaluation of Reliability (Waste Liquid System)

For each example, the clogging of the waste liquid pipe when continuous printing was performed for 2 hours under the conditions of 1200×600 dpi, a PT Duty of 100%, a Bk Duty of 100%, and a Cy Duty of 100%, and nozzle recovery by cleaning was performed 10 times in a state where the waste liquid system was configured by the combination of one head and one cap was confirmed.
A: There is no clogging.
C: There is clogging.

### 3.2.6. Evaluation of Reliability (Mist)

For each example, the number of non-ejection nozzles when continuous printing was performed under the conditions of 1200×600 dpi, a PT Duty of 100%, a Bk Duty of 100%, and a Cy Duty of 100% was confirmed and evaluation was performed according to the following criteria. The results are shown in the table.
AA: Non-ejection for 3 hours or more
A: Non-ejection for 2 hours or more
B: Non-ejection for 1 hour or more
C: Non-ejection occurs in less than 1 hour.

### 3.2.7. Evaluation of Head Number Width (Apparatus Width)

For each example, the number of colors that could be handled with the same number of heads (8 heads) as in ML-8000 was confirmed.
AA: 8 colors (ML-8000)
A: 6 colors
B: 5 colors
C: Less than 4 colors (it is necessary to increase the apparatus width in order to print CMYK which is the basic color)

### 3.2.8. Evaluation of Waste Liquid Consumption

In each example, the minimum required amount of waste liquid (CL mode) required for returning when there was a non-ejection nozzle in continuous printing was confirmed, and evaluation was performed according to the following criteria. The results are shown in the table.
A: Cleaning is not necessary or the nozzle can be recovered by one weak cleaning (small amount of waste liquid).
B: The nozzle can be recovered with one strong cleaning (medium amount of waste liquid).
C: The nozzle is not recovered by two or more cleanings or not sufficiently recovered depending on the conditions of continuous printing (large amount of waste liquid)

### 3.2.9. Evaluation of Rubbing Fastness

The recorded matter obtained by performing recording on a cotton broad cloth under the conditions of 1200×600 dpi, a PT Duty of 100%, a Bk Duty of 100%, and a Cy Duty of 100% according to the conditions of each example was dried 160° C. for 3 minutes, and the rubbing fastness of the recorded matter after drying was evaluated according to the following criteria. The results are shown in the Table. The wet rubbing fastness was evaluated by a method according to ISO-105-X12.
AA: Wet rubbing fastness grade of 4 or higher
A: Wet rubbing fastness grade of 3 to 4
B: Wet rubbing fastness grade of 3

### 3.3. Evaluation Results

As seen from each table, in the ink jet recording method of each example for performing recording by causing the carriage in which the first nozzle row, the second nozzle row, the third nozzle row, the fourth nozzle row, the fifth nozzle row, and the sixth nozzle row extending in the sub-scanning direction in which the recording medium was transported were arranged in this order in the main scanning direction intersecting the sub-scanning direction to perform reciprocating scanning in the main scanning direction, and discharging the first composition, the second composition, the third composition, the fourth composition, the fifth composition, and the sixth composition from the first nozzle row, the second nozzle row, the third nozzle row, the fourth nozzle row, the fifth nozzle row, and the sixth nozzle row, respectively, in both the forward pass and the return pass, the method including the ink attachment step of discharging the ink composition containing the pigment and the resin particles and attaching the ink composition to the recording medium, and the reaction liquid attachment step of discharging the reaction liquid composition containing the aggregating agent that aggregated the components of the ink composition and attaching the reaction liquid composition to the recording medium, in which the distance between the first nozzle row and the third nozzle row in the main scanning direction was equal to a distance between the fourth nozzle row and the sixth nozzle row in the main scanning direction, the distance between the second nozzle row and the third nozzle row in the main scanning direction was equal to a distance between the fourth nozzle row and the fifth nozzle row in the main scanning direction, the first composition and the sixth composition were the same composition, the second composition and the fifth composition were the same composition, the third composition and the fourth composition were the same composition, and the nozzle rows that discharged a composition corresponding to the reaction liquid composition among the first composition, the second composition, and the third composition were provided in each or one independent ink jet head, favorable results were obtained in mage quality, reliability, color developability, and productivity.

The present disclosure includes a configuration substantially the same as the configuration described in the embodiment, for example, a configuration having the same function, method, and result, or a configuration having the same purpose and effect. Further, the present disclosure includes configurations in which non-essential parts of the configuration described in the embodiments are replaced. In addition, the present disclosure includes configurations that achieve the same effects or configurations that can achieve the same objects as those of the configurations described in the embodiment. Further, the present disclosure includes configurations in which a known technology is added to the configurations described in the embodiments.

The following contents are derived from the above-described embodiment and modification example.

An ink jet recording method for performing recording by causing a carriage in which a first nozzle row, a second nozzle row, a third nozzle row, a fourth nozzle row, a fifth nozzle row, and a sixth nozzle row extending in a sub-scanning direction in which a recording medium is transported are arranged in this order in a main scanning direction intersecting the sub-scanning direction to perform reciprocating scanning in the main scanning direction, and discharging a first composition, a second composition, a third composition, a fourth composition, a fifth composition, and a sixth composition from the first nozzle row, the second nozzle row, the third nozzle row, the fourth nozzle row, the fifth nozzle row, and the sixth nozzle row, respectively, in both a forward pass and a return pass,
the method including
an ink attachment step of discharging an ink composition containing a pigment and resin particles and attaching the ink composition to the recording medium, and
a reaction liquid attachment step of discharging a reaction liquid composition containing an aggregating agent that aggregates components of the ink composition and attaching the reaction liquid composition to the recording medium, in which
a distance between the first nozzle row and the third nozzle row in the main scanning direction is equal to a distance between the fourth nozzle row and the sixth nozzle row in the main scanning direction,
a distance between the second nozzle row and the third nozzle row in the main scanning direction is equal to a distance between the fourth nozzle row and the fifth nozzle row in the main scanning direction,
the first composition and the sixth composition are the same composition,
the second composition and the fifth composition are the same composition,
the third composition and the fourth composition are the same composition, and
nozzle rows that discharge a composition corresponding to the reaction liquid composition among the first composition, the second composition, and the third composition are provided in each or one independent ink jet head.

According to the ink jet recording method, the productivity can be increased by performing the recording respectively by the bidirectional carriage scanning. Further, according to this ink jet recording method, by symmetrically arranging the ink composition and the reaction liquid composition discharged from the nozzles, the attachment order of the ink composition and the reaction liquid composition is the same in the forward pass and the return pass, and thus the image quality (permeation unevenness, streaks) and color developability of the recorded matter can be improved. Further, according to this ink jet recording method, by adopting a configuration of an independent head in which only the reaction liquid composition is discharged from the ink jet head that discharges the reaction liquid composition, the distance from the nozzle row that discharges the ink composition is increased to reduce the effect of mist, and the waste liquid system can be separated for the reaction liquid composition and the ink composition. Thus, the reliability of the waste liquid system can also be improved.

In the ink jet recording method,
the ink composition may contain a self-dispersing pigment as the pigment, and
the ink composition may be discharged from the second nozzle row and the fifth nozzle row.

According to this ink jet recording method, since the nozzle row that discharges the ink composition including the self-dispersing pigment is adjacent to the nozzle row that discharges the reaction liquid composition, aggregation due to mist is less likely to occur, and the reliability is further improved. In addition, even in a case in which aggregates are formed, the aggregates of the self-dispersing pigment are easily re-dissociated, and thus the waste liquid consumption at the time of cleaning can be suppressed.

In the ink jet recording method,
the ink composition may contain only a resin dispersed pigment as the pigment,
when the third nozzle row and the fourth nozzle row discharge the reaction liquid composition, the ink composition may be discharged from the first nozzle row and the sixth nozzle row, and
when the first nozzle row and the sixth nozzle row discharge the reaction liquid composition, the ink composition may be discharged from the third nozzle row and the fourth nozzle row.

According to the ink jet recording method, the nozzles that discharge the ink composition including the resin dispersed pigment that easily forms aggregates when coming into contact with the reaction liquid composition are arranged away from the nozzle rows that discharge the reaction liquid composition. Therefore, aggregation caused by mist is less likely to occur, and the reliability is further improved.

In the ink jet recording method,
the first nozzle row and the second nozzle row may be formed in one ink jet head,
the third nozzle row and the fourth nozzle row may be formed in one ink jet head, and
the fifth nozzle row and the sixth nozzle row may be formed in one ink jet head.

According to the ink jet recording method, the width of the carriage on which the ink jet head is mounted can be reduced, and thus the apparatus can be further miniaturized.

The ink jet recording method may further include
a clear ink attachment step of discharging a clear ink composition containing resin particles and attaching the clear ink composition to the recording medium.

According to the ink jet recording method, a recorded matter with more favorable rubbing fastness can be obtained.

In the ink jet recording method,
the aggregating agent may be selected from a polyvalent metal salt, an organic acid, and a cationic polymer.

According to the ink jet recording method, an image with more favorable color developability can be obtained.

In the ink jet recording method,
the recording medium may be a fabric.

The fabric is a permeable medium, and the color development easily changes slightly on a balance between the speed at which the ink composition and reaction liquid composition mix and the components are aggregated and the speed at which the compositions permeate into the fabric. However, according to the ink jet recording method, an image with less unevenness in the color developability can be formed even with respect to such a fabric.

An ink jet recording apparatus including
a carriage in which a first nozzle row, a second nozzle row, a third nozzle row, a fourth nozzle row, a fifth nozzle row, and a sixth nozzle row extending in a sub-scanning direction in which a recording medium is transported are arranged in this order in a main scanning direction intersecting the sub-scanning direction, in which
recording is performed by performing reciprocating scanning in the main scanning direction, and discharging a first composition, a second composition, a third composition, a fourth composition, a fifth composition, and a sixth composition from the first nozzle row, the second nozzle row, the third nozzle row, the fourth nozzle row, the fifth nozzle row, and the sixth nozzle row, respectively, in both a forward pass and a return pass,
a distance between the first nozzle row and the third nozzle row in the main scanning direction is equal to a distance between the fourth nozzle row and the sixth nozzle row in the main scanning direction,
a distance between the second nozzle row and the third nozzle row in the main scanning direction is equal to a distance between the fourth nozzle row and the fifth nozzle row in the main scanning direction,
the first composition and the sixth composition are the same composition,
the second composition and the fifth composition are the same composition,
the third composition and the fourth composition are the same composition,
any one of the first composition, the second composition, and the third composition is a reaction liquid composition containing an aggregating agent, and
nozzle rows that discharge a composition corresponding to the reaction liquid composition among the first composition, the second composition, and the third composition are provided in each or one independent ink jet head.

According to the ink jet recording apparatus, the productivity can be increased by performing the recording respectively by the bidirectional carriage scanning. Further, according to this ink jet recording apparatus, by symmetrically arranging the ink composition and the reaction liquid composition discharged from the nozzles, the attachment order of the ink composition and the reaction liquid composition is the same in the forward pass and the return pass, and thus the image quality (permeation unevenness, streaks) and color developability of the recorded matter can be improved. Further, according to this ink jet recording apparatus, by adopting a configuration of an independent head in which only the reaction liquid composition is discharged from the ink jet head that discharges the reaction liquid composition, the distance from the nozzle row that discharges the ink composition is increased to reduce the effect of mist, and the waste liquid system can be separated for the reaction liquid composition and the ink composition. Thus, the reliability of the waste liquid system can also be improved.

What is claimed is:

1. An ink jet recording method for performing recording by causing a carriage in which a first nozzle row, a second nozzle row, a third nozzle row, a fourth nozzle row, a fifth nozzle row, and a sixth nozzle row extending in a sub-scanning direction in which a recording medium is transported are arranged in this order in a main scanning direction intersecting the sub-scanning direction to perform reciprocating scanning in the main scanning direction, and discharging a first composition, a second composition, a third composition, a fourth composition, a fifth composition, and a sixth composition from the first nozzle row, the second nozzle row, the third nozzle row, the fourth nozzle row, the fifth nozzle row, and the sixth nozzle row, respectively, in both a forward pass and a return pass,
the method comprising:
an ink attachment step of discharging an ink composition containing a pigment and resin particles and attaching the ink composition to the recording medium; and
a reaction liquid attachment step of discharging a reaction liquid composition containing an aggregating agent that aggregates components of the ink composition and attaching the reaction liquid composition to the recording medium, wherein
a distance between the first nozzle row and the third nozzle row in the main scanning direction is equal to a distance between the fourth nozzle row and the sixth nozzle row in the main scanning direction,
a distance between the second nozzle row and the third nozzle row in the main scanning direction is equal to a distance between the fourth nozzle row and the fifth nozzle row in the main scanning direction,
the first composition and the sixth composition are the same composition,
the second composition and the fifth composition are the same composition,
the third composition and the fourth composition are the same composition, and
nozzle rows that discharge a composition corresponding to the reaction liquid composition among the first composition, the second composition, and the third composition are provided in each or one independent ink jet head.

2. The ink jet recording method according to claim 1, wherein
the ink composition contains a self-dispersing pigment as the pigment, and
the ink composition is discharged from the second nozzle row and the fifth nozzle row.

3. The ink jet recording method according to claim 1, wherein
the ink composition contains only a resin dispersed pigment as the pigment,
when the third nozzle row and the fourth nozzle row discharge the reaction liquid composition, the ink composition is discharged from the first nozzle row and the sixth nozzle row, and
when the first nozzle row and the sixth nozzle row discharge the reaction liquid composition, the ink composition is discharged from the third nozzle row and the fourth nozzle row.

4. The ink jet recording method according to claim 1, wherein
the first nozzle row and the second nozzle row are formed in one ink jet head,
the third nozzle row and the fourth nozzle row are formed in one ink jet head, and
the fifth nozzle row and the sixth nozzle row are formed in one ink jet head.

5. The ink jet recording method according to claim 1, further comprising:
a clear ink attachment step of discharging a clear ink composition containing resin particles and attaching the clear ink composition to the recording medium.

6. The ink jet recording method according to claim 1, wherein
the aggregating agent is selected from a polyvalent metal salt, an organic acid, and a cationic polymer.

7. The ink jet recording method according to claim 1, wherein
the recording medium is a fabric.

8. An ink jet recording apparatus comprising:
a carriage in which a first nozzle row, a second nozzle row, a third nozzle row, a fourth nozzle row, a fifth nozzle row, and a sixth nozzle row extending in a sub-scanning direction in which a recording medium is transported are arranged in this order in a main scanning direction intersecting the sub-scanning direction, wherein
recording is performed by performing reciprocating scanning in the main scanning direction, and discharging a first composition, a second composition, a third composition, a fourth composition, a fifth composition, and a sixth composition from the first nozzle row, the second nozzle row, the third nozzle row, the fourth nozzle row, the fifth nozzle row, and the sixth nozzle row, respectively, in both a forward pass and a return pass,
a distance between the first nozzle row and the third nozzle row in the main scanning direction is equal to a distance between the fourth nozzle row and the sixth nozzle row in the main scanning direction,
a distance between the second nozzle row and the third nozzle row in the main scanning direction is equal to a distance between the fourth nozzle row and the fifth nozzle row in the main scanning direction,
the first composition and the sixth composition are the same composition,
the second composition and the fifth composition are the same composition,
the third composition and the fourth composition are the same composition,
any one of the first composition, the second composition, and the third composition is a reaction liquid composition containing an aggregating agent, and
nozzle rows that discharge a composition corresponding to the reaction liquid composition among the first composition, the second composition, and the third composition are provided in each or one independent ink jet head.
